(19) United States
(12) Patent Application Publication
(10) Pub. No.: US 2026/0186688 A1
(43) Pub. Date: Jul. 2, 2026

(54) METHOD AND SYSTEM FOR UNLEARNING OF LARGE LANGUAGE MODEL, AND METHOD FOR CONTROLLING UNLEARNING SYSTEM OF LARGE LANGUAGE MODEL

(71) Applicant: LG MANAGEMENT DEVELOPMENT INSTITUTE CO., LTD., Seoul (KR)

(72) Inventors: Sung Jun CHO, Seoul (KR); Da Sol HWANG, Seoul (KR); Moon Tae LEE, Gyeonggi-do (KR)

(21) Appl. No.: 19/543,874

(22) Filed: Feb. 19, 2026

Related U.S. Application Data
(63) Continuation of application No. PCT/KR2025/009053, filed on Jun. 27, 2025.

(30) Foreign Application Priority Data
Aug. 29, 2024 (KR) 10-2024-0116923
Apr. 16, 2025 (KR) 10-2025-0049766
Apr. 29, 2025 (KR) 10-2025-0056406

(51) Int. Cl. G06F 3/06

(52) U.S. Cl. CPC G06F 3/0652; G06F 3/0604; G06F 3/0673

(57) ABSTRACT

A method and system for unlearning of a large language model perform operations comprising specifying data to be forgotten and data to be retained for a pre-trained large language model in a training dataset stored in memory; specifying a parameter having a high importance based on a preset reference criterion for the data to be forgotten among a plurality of parameters of the large language model by comparing the data to be forgotten and the data to be retained; initializing a weight of low-rank adaptation based on the parameter having the high importance for the data to be forgotten; and performing unlearning on the large language model based on the weight of the low-rank adaptation.

### CROSS-REFERENCE TO RELATED APPLICATIONS

This application is a continuation of International Patent Application No. PCT/KR2025/009053, filed on Jun. 27, 2025, which claims the benefit of and priority to Korean Patent Application No. 10-2024-0116923, filed on Aug. 29, 2024, Korean Patent Application No. 10-2025-0049766, filed on Apr. 16, 2025, and Korean Patent Application No. 10-2024-0116923, filed on Apr. 29, 2025, the entire disclosures of which are hereby incorporated herein by reference in their entireties.

### BACKGROUND

### Technical Field

The present disclosure generally relates to a method and system for unlearning of a large language model, and a method for controlling an unlearning system of a large language model. And, the present invention also generally relates to a method and system for unlearning of a large language model capable of optimizing a large language model, and a method for controlling an unlearning system of a large language model.

### Related Art

The term artificial intelligence may refer to a technology that enables a computer program to emulate human capabilities such as learning, reasoning, perception, natural language understanding. Recent advancements in deep learning have driven rapid development in artificial intelligence.

Driven by the advancement in artificial intelligence, numerous language models have been developed, and these language models not only recognize text and understand its meaning but also extract and classify information from data including a vast text such as a document, etc., and further to generate text autonomously.

The language models are actively utilized across various fields, for example, a search engine, document writing (e.g., resume writing, report writing, post writing, etc.), free conversation on various topics, data parsing from given text (e.g., data summarization, classification, etc.), provision of expert knowledge, programming, conversion of a given sentence into a sentence of an appropriate style, and the like. These applications broadly encompass tasks that may be performed based on text.

Recently, through pre-training on vast amounts of text data, a large language model (LLM) capable of understanding and generating human language has emerged. Unlike manually constructed chatbots that provide limited answers or responses, the LLM enables natural communicate approaching human-level fluency, and shows technical capabilities for providing fast and accurate information, and represent an innovation in an artificial intelligence market.

Such a large language model demonstrates strong reasoning ability and memory ability. However, during the process of learning text provided by humans, there are inherently risks related to personal information protection and copyright infringement.

To mitigate these risks while improving the overall performance of the large language model, there is a need for an efficient optimization method capable of effectively removing knowledge regarding sensitive data.

### SUMMARY

According to some embodiments of the present disclosure, a method and system for unlearning of a large language model, and a method for controlling an unlearning system of a large language model may be capable of effectively removing data to be removed and increasing an efficiency for data to be retained.

More specifically, according to certain embodiments of the present disclosure, a method and system for unlearning of a large language model, and a method for controlling an unlearning system of a large language model may be capable of removing knowledge regarding data to be removed while retaining knowledge regarding data to be retained.

Further, according to some embodiments of the present disclosure, a method and system for unlearning of a large language model, and a method for controlling an unlearning system of a large language model may be capable of efficiently removing data to be removed without affecting reasoning ability and generation ability of a large language model.

In addition, according to certain embodiments of the present disclosure, a method and system for optimizing a large language model, and a method for controlling a large language model optimization system may be capable of improving learning efficiency of the large language model.

Additionally, according to some embodiments of the present disclosure, a method and system for optimizing a large language model may improve learning speed and reasoning speed of the large language model.

Further, according to certain embodiments of the present disclosure, a method and system for optimizing a large language model, and a method for controlling a large language model optimization system may be capable of improving reasoning performance of the large language model and achieving cost-efficient learning.

According to some embodiments of the present disclosure, a method for unlearning of a large language model, which is computerized, may comprise: specifying forgetting data and retaining data for a pre-trained large language model (LLM) in a training dataset stored in a memory; specifying a specific parameter having a high importance for the forgetting data among parameters of the large language model by comparing the forgetting data and the retaining data; initializing a weight of LoRA (Low-Rank Adaptation) based on the specific parameter having the high importance for the forgetting data; and performing unlearning for the large language model to which the weight of LoRA is applied.

In an embodiment, the method may further comprise: measuring a parameter importance for each of the forgetting data and the retaining data by using a Fisher information matrix.

In an embodiment, the Fisher information matrix may be a measure indicating whether at least one parameter of the large language model is important for a text sample included in the forgetting data or the retaining data.

In an embodiment, a parameter having a high absolute value of a gradient for the forgetting data may be specified as having a relatively high importance in the forgetting data, and a parameter having a high absolute value of a gradient for the retaining data may be specified as having a relatively high importance in the retaining data.

In an embodiment, in the measuring, for each parameter of the large language model, a Fisher information matrix for the forgetting data and a Fisher information matrix for the retaining data may be measured by using the forgetting data and the retaining data, and the parameter importance may be measured by using the Fisher information matrix for the forgetting data and the Fisher information matrix for the retaining data.

In an embodiment, the parameter importance may be measured by using a relative Fisher information matrix between the Fisher information matrix for the forgetting data and the Fisher information matrix for the retaining data.

In an embodiment, the relative Fisher information matrix may be calculated by using the Fisher information matrix for the forgetting data and the Fisher information matrix for the retaining data.

In an embodiment, based on the relative Fisher information matrix, a parameter having a high parameter importance for the forgetting data may be specified as the specific parameter.

In an embodiment, the specification of the specific parameter may be performed by specifying, as the specific parameter, a parameter having a high importance for the forgetting data and a low importance for the retaining data.

In an embodiment, the initialization may be performed by calculating a relative importance of parameters for each of the forgetting data and the retaining data.

In an embodiment, in the performing of the initialization, the weight of LoRA may be initialized, centered on the specific parameter having a high importance for the forgetting data.

In an embodiment, among the forgetting data and the retaining data, important information for the forgetting data may be specified and reflected in the initialization.

In an embodiment, in the performing of the unlearning, the unlearning may be performed for the forgetting data by using a preset loss function for unlearning in the large language model.

In an embodiment, in the performing of the unlearning, the unlearning may be performed for the large language model by using the loss function so that a prediction probability for the retaining data of the large language model is increased and a prediction probability for the forgetting data of the large language model is decreased.

In an embodiment, in the performing of the unlearning, a prediction probability of the large language model for a true token included in the forgetting data may be decreased, and a prediction probability of the large language model for an alternative token having a highest probability among all tokens excluding the true token may be increased so that a prediction probability for the forgetting data is decreased.

In an embodiment, the alternative token may correspond to one token having a highest possibility of replacing the true token among all tokens excluding the true token.

In an embodiment, while unlearning is performed in the large language model, parameters of the large language model are fixed, and only the weights of LoRA may be updated.

According to certain embodiments of the present disclosure, a method for controlling an unlearning system of a large language model may comprise: receiving a user input requesting deletion of specific data among a training dataset used in training of a large language model (LLM); specifying, as forgetting data, data corresponding to the specific data in the training dataset based on the received user input, and specifying, as retaining data, remaining data excluding the forgetting data; specifying a specific parameter having a high importance for the forgetting data among parameters of the large language model by comparing the forgetting data and the retaining data; initializing a weight of LoRA (Low-Rank Adaptation) based on the specific parameter having a high importance for the forgetting data; and performing unlearning for the large language model to which the weight of LoRA is applied.

According to some embodiments of the present disclosure, an unlearning system of a large language model may comprise: a memory configured to store executable instructions; and one or more processors configured to perform an operation by executing one or more instructions, in which the unlearning system: may specify forgetting data and retaining data for a pre-trained large language model (LLM) in a training dataset stored in the memory; specify a specific parameter having a high importance for the forgetting data among parameters of the large language model by comparing the forgetting data and the retaining data; initialize a weight of LoRA (Low-Rank Adaptation) based on the specific parameter having a high importance for the forgetting data; and perform unlearning for the large language model to which the weight of LoRA is applied.

According to certain embodiments of the present disclosure, a program stored in a computer-readable recording medium, and executed by one or more processes in an electronic device may comprise instructions for performing: specifying forgetting data and retaining data for a pre-trained large language model (LLM) in a training dataset; specifying a specific parameter having a high importance for the forgetting data among parameters of the large language model by comparing the forgetting data and the retaining data; initializing a weight of LoRA (Low-Rank Adaptation) based on the specific parameter having a high importance for the forgetting data; and performing unlearning for the large language model to which the weight of LoRA is applied.

According to some embodiments of the present disclosure, a method for optimizing a large language model, which is computerized, may comprise: specifying forgetting data and retaining data for a large language model trained with a training dataset; specifying a specific parameter having a high importance for the forgetting data among parameters of the trained large language model by using the forgetting data and the retaining data; initializing a weight of a preset adapter based on the importance of the specific parameter; and performing unlearning for the trained large language model to which the initialized weight of the adapter is applied.

In an embodiment, the trained large language model may be a model in which training for the training dataset is performed based on a preset attention mechanism.

In an embodiment, the trained large language model may be trained based on the attention mechanism for long-context modeling.

In an embodiment, when at least one text sequence included in the training dataset is input to the large language model, the trained large language model may perform an attention operation only for some query-key pairs selected according to a preset criterion among entire query-key pairs included in the input text sequence.

In an embodiment, the trained large language model may be trained so as to process tokens included in the text sequence, in a process of processing the text sequence through the attention mechanism, by processing in units of sliding-window (sliding-window attention), or by selecting and processing in units of blocks (blockwise), or by processing based on importance.

In an embodiment, the trained large language model may be trained by using at least one of a low-precision training technique or a mixed precision training technique.

In an embodiment, the trained large language model may correspond to a teacher model configured to distill knowledge learned through the training for the training dataset into at least one model corresponding to a student model.

In an embodiment, the method may further comprise: measuring a parameter importance for each of the forgetting data and the retaining data by using an empirical Fisher information matrix, in which the empirical Fisher information matrix may be a measure indicating whether at least one parameter of the trained large language model is important for a text sample included in the forgetting data or the retaining data.

In an embodiment, in the measuring, for each parameter of the trained large language model, an empirical Fisher information matrix for the forgetting data and an empirical Fisher information matrix for the retaining data may be measured by using the forgetting data and the retaining data, and the parameter importance may be measured by using the empirical Fisher information matrix for the forgetting data and the empirical Fisher information matrix for the retaining data.

In an embodiment, the parameter importance may be measured by using a relative Fisher information matrix between the empirical Fisher information matrix for the forgetting data and the empirical Fisher information matrix for the retaining data.

In an embodiment, the relative Fisher information matrix may be calculated by using the Fisher information matrix for the forgetting data and the Fisher information matrix for the retaining data.

In an embodiment, in the specification of the specific parameter, a parameter having a high parameter importance for the forgetting data may be specified as the specific parameter.

In an embodiment, the specification of the specific parameter may be performed by specifying, as the specific parameter, a parameter having a high importance for the forgetting data and a low importance for the retaining data.

In an embodiment, the initialization may be performed by calculating a relative importance of parameters for each of the forgetting data and the retaining data.

In an embodiment, in the performing of the initialization, the weight of the adapter may be initialized, centered on the specific parameter having a high importance for the forgetting data.

In an embodiment, in the performing of the unlearning, the unlearning may be performed for the forgetting data by using a preset loss function for unlearning in the trained large language model.

In an embodiment, in the performing of the unlearning, the unlearning may be performed for the trained large language model by using the loss function so that a prediction probability for the retaining data of the trained large language model is increased and a prediction probability for the forgetting data of the large language model is decreased.

In an embodiment, while unlearning is performed in the large language model, parameters of the large language model are fixed, and only the weight of the LoRA adapter may be updated.

According to certain embodiments of the present disclosure, a large language model optimization system may comprise: a memory configured to store executable instructions; and one or more processors configured to perform an operation by executing the one or more instructions, according to the present invention. The large language model optimization system may: specify forgetting data and retaining data for a large language model trained with a training dataset; specify a specific parameter having a high importance for the forgetting data among parameters of the trained large language model by using the forgetting data and the retaining data; initialize a weight of a preset adapter based on the importance of the specific parameter; and perform unlearning for the trained large language model to which the initialized weight of the adapter is applied.

According to some embodiments of the present disclosure, a program stored in a computer-readable recording medium, and executed by one or more processes in an electronic device, may comprise instructions for performing: specifying forgetting data and retaining data for a large language model trained with a training dataset; specifying a specific parameter having a high importance for the forgetting data among parameters of the trained large language model by using the forgetting data and the retaining data; initializing a weight of a preset adapter based on the importance of the specific parameter; and performing unlearning for the trained large language model to which the initialized weight of the adapter is applied.

According to some embodiments of the present disclosure, a method and system for unlearning of a large language model and a method for controlling an unlearning system of a large language model may calculate or measure Fisher information for each of forgetting data and retaining data, and perform the unlearning on the large language model based on the calculated or measured result. Accordingly, in certain embodiments of the present disclosure, by selecting and preferentially adjusting only relatively important parameters (or weights) for forgetting data (e.g., data to be forgotten), knowledge regarding retaining data (e.g., data to be retained) may be retained, while knowledge regarding the forgetting data may be effectively removed. Through this, some embodiments of the present disclosure may reduce or minimize influence on the retaining data, while more quickly unlearning the forgetting data, thereby maintaining or improving an existing performance of the model.

In addition, according to certain embodiments of the present disclosure, a method and system for unlearning of a large language model and a method for controlling an unlearning system of a large language model may analyze relative importance for the forgetting data and the retaining data, and perform an initialization operation of selectively adjusting only important parameters for the forgetting data based on the analyzed result. Through this, some embodiments of the present disclosure may reduce unnecessary operation in an unlearning process, and save calculation cost, and efficiently perform the unlearning operation in terms of time and resources without re-training an entire model.

Further, according to some embodiments of the present disclosure, a method and system for unlearning of a large language model and a method for controlling an unlearning system of a large language model may concentrating gradient update only on a minimum number of alternative tokens (viable replacements) having a high replaceability of a true token, data to be removed may be effectively removed, while language generation ability and reasoning performance of the existing model may be maintained. Through this, certain embodiments of the present disclosure may prevent or reduce performance degradation that may occur in a process of information deletion of the model, and provide an environment capable of solving privacy protection and copyright problems. That is, some embodiments of the present disclosure may prevent unnecessary loss diffusion and perform effective unlearning and maintain or improve natural sentence generation ability of the model by adjusting only a minimum number of alternative tokens having a high replaceability, even in a situation where unlearning for specific data is to be achieved.

According to certain embodiments of the present disclosure, by preferentially adjusting important parameters in the forgetting data and minimizing information loss of the retaining data, only specific data may be removed without retraining the entire model, so that operation cost and operational (maintenance or management) cost may be greatly reduced. In some embodiments of the present disclosure, data that a user wants to delete may be quickly unlearned, thereby complying with data protection laws, reducing enterprise operational cost, improving reliability of an AI system, and the like, and therefore the present disclosure may be usefully utilized in various industries or services.

### BRIEF DESCRIPTION OF DRAWINGS

FIG. 1 is a conceptual view for describing unlearning of a large language model according to an embodiment of the present disclosure.

FIG. 2 is a block diagram of an unlearning system of a large language model according to an embodiment of the present disclosure.

FIGS. 3 and 4 are flowcharts for describing a method for unlearning of a large language model according to an embodiment of the present disclosure.

FIGS. 5 and 6 are conceptual views for describing a method for unlearning of a large language model according to an embodiment of the present disclosure.

FIGS. 7-11 are equations related to a method for unlearning of a large language model according to an embodiment of the present disclosure.

FIG. 12 is a flowchart for describing a method for controlling an unlearning system of a large language model according to an embodiment of the present disclosure.

FIG. 13 is a conceptual view for describing a method for controlling an unlearning system of a large language model according to an embodiment of the present disclosure.

### DETAILED DESCRIPTION OF EMBODIMENTS

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical teachings disclosed in the present specification are not limited by the accompanying drawings, and includes all alterations, equivalents, and alternatives that are included in the teachings and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present disclosure, it should be understood that terms “including”, “having”, and the like are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present disclosure generally relates to a method and system for large language model unlearning, and a method for controlling a system for performing unlearning on a large language model. Some embodiments of the present disclosure relate to a method and system for unlearning a large language model, thereby effectively removing data to be removed and increasing efficiency for data to be retained, and a method for controlling an unlearning system of a large language model.

The large language model (LLM) has reasoning and storing capability through pre-training on a vast amount of text data. However, the large language model (LLM) may need to protect personal information and have a risk of copyright infringement in a process of learning text provided by a human.

Therefore, an operation of unlearning for removing sensitive data (i.e., data to be removed) related to personal information protection and copyright infringement may be required. The unlearning may mean a process of intentionally removing or deleting, or modifying information, patterns, or knowledge that the large language model (LLM) has previously or in advance learned. For example, the unlearning may be a method of removing or modifying the learned content when the large language model (LLM) has learned incorrect information, inappropriate bias, or unintended data.

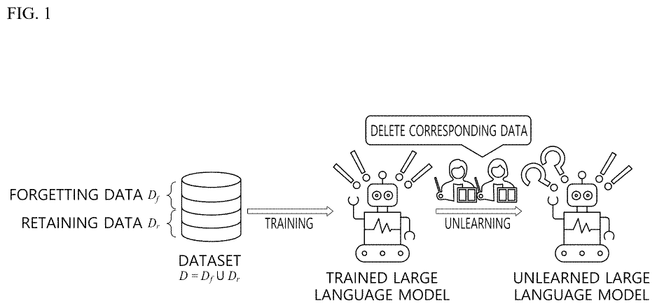

Referring to FIG. 1, the unlearning of the large language model may be performed to fine-tune a pre-trained large language model so as to remove or delete knowledge regarding a dataset to be removed (e.g., “Forget set”). For example, a dataset to be removed, forgotten, or deleted may include text data requested to be deleted from a user. In the operation of the unlearning, the large language model may be required to forget knowledge regarding data included in a dataset to be removed, and to retain knowledge regarding data included in a dataset to be retained (e.g., “Retain set”), and also to retain reasoning ability and generation ability previously acquired.

Accordingly, certain embodiments of the present disclosure may provide a method and system for allowing a large language model to be unlearned to efficiently remove data to be removed while retaining knowledge regarding data to be retained, without affecting reasoning ability and generation ability of the large language model.

Some embodiments of the present disclosure may be usefully utilized in various situations. More specifically, according to some embodiments of the present disclosure, a method and system for allowing a large language model to be unlearned may be applied to various industries and services, and may be usefully utilized. For example, a method and system for allowing a large language model to be unlearned according to an embodiment of the present disclosure may be usefully utilized by being applied to a system, application, software, web-site, and program based on a language model (e.g., a large language model).

Accordingly, certain embodiments of the present disclosure may be usefully utilized in various industries and services requiring unlearning of a large language model (e.g., natural language generation related services, conversational AI and chatbot, text generation AI and content generation, customized education and language learning, social media and online platforms, harmful content filtering, medical and healthcare, finance and law, game and virtual environment, etc.).

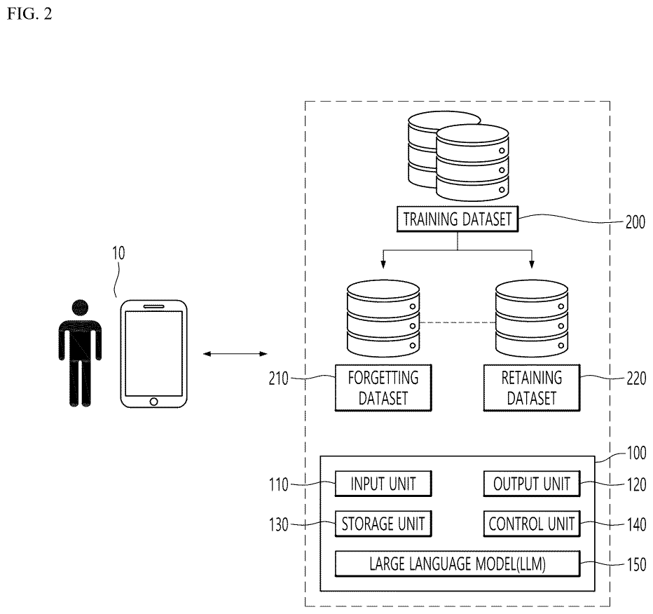

Referring to FIG. 2, a system 100 of unlearning of a large language model (hereinafter “unlearning system” according to an embodiment of the present disclosure may include at least one of an input unit 110, an output unit 120, a storage unit 130, a control unit or controller 140, or a large language model 150.

The unlearning system 100 according to an embodiment of the present disclosure may include at least one processor and at least one memory including a computer program code and/or executable instructions which can be executed by at least one processor. The storage unit 130 may serve as the memory. The memory and the program code may cooperate with the processor to perform a series of operations or processes described below.

The unlearning system 100 according to an embodiment of the present disclosure may include one or more processors. The processor may include one or more general-purpose processors and/or one or more special-purpose processors (for example, a digital signal processor, a tensor processing unit (TPU), a graphics processing unit (GPU), a neural processing unit (NPU), an application-specific integrated circuit, an application-specific integrating circuit (ASIC), a field programmable gate array (FPGA), a quantum processing device (or quantum processor, QPU), etc.). The processor may be configured to execute instructions, computer-readable directives, and/or any other instructions which are stored or included in the storage unit 130. The unlearning system and method according to an embodiment of the present disclosure may process data by cooperation between a memory and at least one processor. The processor may perform a series of operations (computations or calculations) and data processing using data, instructions, and information stored in the memory. The memory may be configured to be the storage unit 130.

In addition, the unlearning system 100 according to an embodiment of the present disclosure may perform data processing and calculation using a quantum gate, quantum entanglement, and a quantum superposition state, in consideration of implementation in a quantum computer environment. For example, certain embodiments of the present disclosure may perform parallel operation based on qubits, and such quantum operations may operate complementarily with a conventional classical computer.

In the quantum computer, a high-speed data processing device that utilizes parallel operation using qubits and quantum entanglement may be included, and hardware-based operation optimization using an FPGA and an ASIC may be performed. In addition, in the quantum computer, a quantum processor capable of performing parallel operation based on qubits may be used, and data processing efficiency may be improved through a hybrid structure with a computer.

The input unit 110 may be configured to input data, and may be configured in various types. For example, the input unit 110 may be configured to receive an input from a user. For example, the input unit 110 may be configured to receive user input from the user terminal 10. For example, the operation of receiving an input may comprise an operation of receiving an input signal or selection signal corresponding to the user input, based on the input being made by the user through input unit configuration provided in the user terminal 10.

The user terminal 10 may include, for example, but not limited to, a cell phone, a smart phone, a notebook computer, a portable computer, a laptop computer, a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), and a head mounted display (HMD)).

In addition, in an embodiment of the present disclosure, the input unit 110 may not be a hardware means, but may be a channel for receiving input from a user.

The input unit 110 may include a user interface module. The input unit 110 may include a touch screen, computer mouse, keyboard, keypad, touch pad, trackball, joystick, voice recognition module, or other similar devices. However, in the present disclosure, the types of the input unit 110 are not limited thereto.

Here, the user input may include, for instance, but not limited to, a document, text, image or video, voice, and the like. The unlearning system 100 may further include a module for converting voice into text.

The output unit 120 may output information through an output unit configuration (e.g., a display unit, touch screen, speaker, etc.) provided in the user terminal 10 operably associated with the unlearning system 100 according to an embodiment of the present disclosure. For example, the output unit 120 may output a page (e.g., a service page) linked with the unlearning system 100 according to an embodiment of the present disclosure to a display unit of the user terminal 10. In addition, the output unit 120 may not be a hardware means, but may be a channel for outputting results to a user.

The storage unit 130 (such as a memory) may store various data related to some operations of an embodiment of the present disclosure. The storage unit 130 may include one or more non-transitory computer-readable storage media that may be read and/or accessed or retrieved by at least one processor.

The computer-readable storage media may include volatile and/or non-volatile storage constituent elements, such as optical, magnetic, organic, or other memory or disk storage devices. In some embodiments, the storage unit 130 may be implemented as a single physical device (e.g., one optical, magnetic, organic, or other memory or disk storage device). However, in other embodiments, the storage unit 130 may be implemented as the plurality of physical devices.

The storage unit 130 may include computer-readable directives and additional data. The storage unit 130 may include storage necessary to perform at least part of one or more operations, methods, scenarios, and technologies and/or at least part of one or more functions of the devices and networks described in the present disclosure.

Further, at least a part of the storage unit 130 may be implemented as a cloud storage or a cloud server. At least a part of data corresponding to the user input received from the input unit 110 or training data or training dataset may be stored in the storage unit 130.

The storage unit 130 may have a sufficient space where information necessary for the operation of the unlearning system 100 is stored, and it may be understood that there are no constraints on physical space.

Further, the storage unit 130 may store a computer program and instructions for the computer program. Further, the storage unit 130 may store a computer program and computer program instructions that, when loaded to or executed by a processor of the system 100, control operation of the system 100 or operation of the control unit 140.

Next, the control unit 140 may be configured to control overall operation of the unlearning system 100. The control unit 140 may process signals, data, instructions, information, and the like that are input or output through the constituent elements of the unlearning system 100 described above, or perform a series of data processing to provide or process appropriate information and functions to the user. For instance, the control unit 140 may be physically implemented as a processor described above.

Meanwhile, the large language model 150 may be a pre-trained (or previously trained) model using a training dataset. The large language model 150 may perform pre-training on large-scale text data (or a text corpus, text data, text samples, text sequences, token sequences, language data, etc.) included (or configured) in the training dataset. The large language model 150 may model a likelihood of a sequence through next-token prediction when a token sequence (or text sequence) of a predetermined length (T) is given.

In one embodiment, after pre-training of the large language model 150 is completed, it is assumed that a user has requested to delete specific data (or a specific dataset) from the training dataset used in training of the large language model 150. In the present disclosure, specific data that a user wants to remove (perform unlearning) may be referred to as “forgetting data” or “forgetting dataset”. In addition, in the present disclosure, even after unlearning of the forgetting data 210 is completed, data including knowledge that the large language model 150 must not remove, forget, or unlearn may be referred to as “retaining data” or “retaining dataset”.

In this case, in an unlearning process, by maximizing next-token prediction loss of at least one text sequence included in the forgetting data 210, the large language model 150 may unlearn the text sequence, in order to assign a low probability to the forgetting data 210.

Here, maximizing the prediction loss may mean maximizing the next-token prediction loss through gradient ascent, which is opposite to gradient descent. Unlike gradient descent (or steepest descent, gradient descent method, etc.), which increases prediction probability (or prediction score, generation probability, generation score, etc.) for a ground truth of the model by minimizing a loss function, gradient ascent (or steepest ascent, gradient ascent method) decreases prediction probability for a ground truth by maximizing a loss function. In relation thereto, a log-likelihood may be implemented as a cross-entropy loss for incremental tokens. The gradient ascent may adjust the model to maximize the cross-entropy loss.

As such, the above-described gradient ascent causes the model to be trained in a direction that reduces a probability assigned a true token while increasing probabilities of remaining tokens. That is, the model is to be trained to increase the probabilities of all tokens other than the ground truth token.

Therefore, maximizing a prediction loss may mean adjusting a probability distribution of the large language model to induce the large language model 150 not to learn or not to predict a specific text sequence. For example, in order for the large language model 150 to predict specific tokens, which have been predicted with high probability, with lower probability, by maximizing the prediction loss for the specific tokens to decrease prediction probability for the specific tokens, the large language model 150 may adjust the probability distribution so as to perform inaccurate prediction regarding the specific tokens (i.e., suppression of generation of forgetting data, suppression of generation of inappropriate sentence, etc.).

However, in the present disclosure, in order to prevent i) a loss not converging and increasing or diverging without a finite boundary, ii) unnecessary additional forgetting occurring by increase of logits for all other tokens, or iii) unstable results occurring in an optimization process, the probability distribution of the model is adjusted in a direction of decreasing prediction probability for a true token while not increasing prediction probability for all tokens other than the true token, and increasing prediction probability (e.g., a loss function) for the token (alternative token) having the highest probability among all tokens other than the true token. That is, in an embodiment of the present disclosure, a method of adjusting the model by concentrating gradient updates only on a minimum number of alternative tokens having high replaceability of a true token is used. More detailed description thereof will be described later.

According to an embodiment of the present disclosure, a method for controlling an unlearning system of a large language model may effectively remove knowledge regarding data to be removed, while retaining knowledge regarding data to be retained. More specifically, in an embodiment of the present disclosure, a method for unlearning of a large language model may efficiently remove data to be removed without affecting reasoning ability and generation ability of the large language model, and hereinafter, some embodiments of a method for unlearning of a large language model according to the present disclosure will be described in more detail.

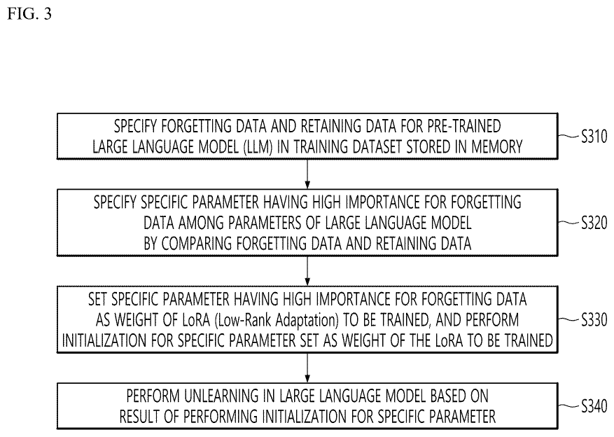

First, in an embodiment of the present disclosure, at step S310 of FIG. 3, in a training dataset stored in a memory, an operation of specifying forgetting data and retaining data for a pre-trained large language model (LLM) may be performed.

The control unit 140 may respectively specify forgetting data (e.g., “forget set”), which corresponds to data of which a learned result is to be removed, among data trained previously (or in advance) for the large language model 150, and retaining data (e.g., “retain set”), which corresponds to data of which a learned result is to be retained.

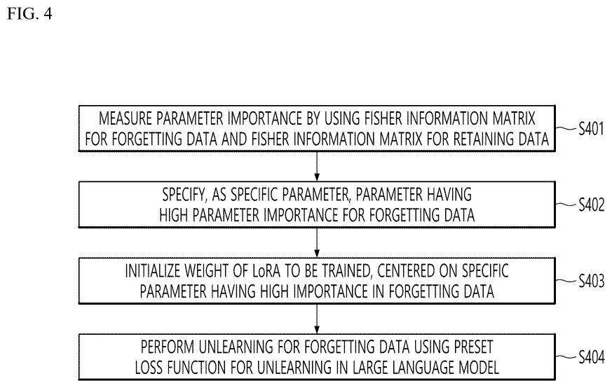

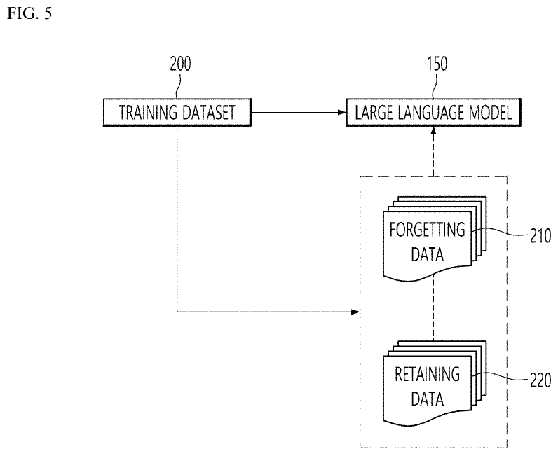

As illustrated in FIG. 4, the control unit 140 may specify training data to be unlearned so as to be unrecognizable through the large language model 150 in a training dataset 200 used in a training process of the large language model 150, as forgetting data 210, and may specify training data to be retained in a recognizable state through the large language model 150 as retaining data 220.

For example, the control unit 140 may specify, as the forgetting data 210, a text sample (or text data, text sequence, token sequence, language data, etc.), which is a target to be removed (i.e., target for removal), in the training dataset 200 used in training of the large language model 150, so as to be unrecognizable through the large language model 150.

In another example, the control unit 140 may specify, as the retaining data 220, a text sample to be retained in a recognizable state through the large language model 150 in the training dataset 200 used in training of the large language model 150.

In the present disclosure, various manners for specifying forgetting data and retaining data may be implemented. In an embodiment the present disclosure, specification of forgetting data and retaining data may be specified based on user input (or request), or may be specified by the unlearning system 100 itself.

In one embodiment, after the pre-training of the large language model 150 is completed, when a user requests deletion of specific data from the training dataset 200 used in the training of the large language model 150, the control unit 140 may specify the specific data requested by the user (e.g., data received from the user terminal 10) as forgetting data 210, and may specify remaining data other than the specified forgetting data 210 as the retaining data 220.

In another embodiment, the unlearning system 100 may analyze the training dataset 200 used in the training process of the large language model 150 based on preset criteria (or conditions). For instance, the preset criteria may be criteria set in relation to user's personal information (e.g., name, address, phone number, email, etc.) or copyright infringement factors. As a result of the analysis, when data related to the preset criteria is detected (or filtered) in the training dataset 200 used in training of the large language model 150, the unlearning system 100 may specify the detected data as the forgetting data 210, and may specify remaining data other than the specified forgetting data 210 as the retaining data 220.

In yet another embodiment, when the unlearning system 100 performs fine-tuning so that only recognition for text data corresponding to a specific item (or type) is possible for the large language model 150 trained based on large-scale text data, the training data related to data corresponding to the specific item may be specified as the retaining data 220, and the training data related to data corresponding to an item other than the specific item may be specified as the forgetting data 210.

In this case, the unlearning system 100 may be understood as performing unlearning for data corresponding to the other item, and here, the specific item or the other item may be understood to refer to a category (or type) for data recognizable through the large language model 150.

In addition, the retaining data 220 may include not only previously learned data for the large language model 150, but also training data related to an item to be newly trained.

However, in the present disclosure, a manner or method of specifying the forgetting data 210 and the retaining data 220 is not necessarily limited to the embodiments described herein, and the forgetting data 210 and the retaining data 220 may be specified according to various manners.

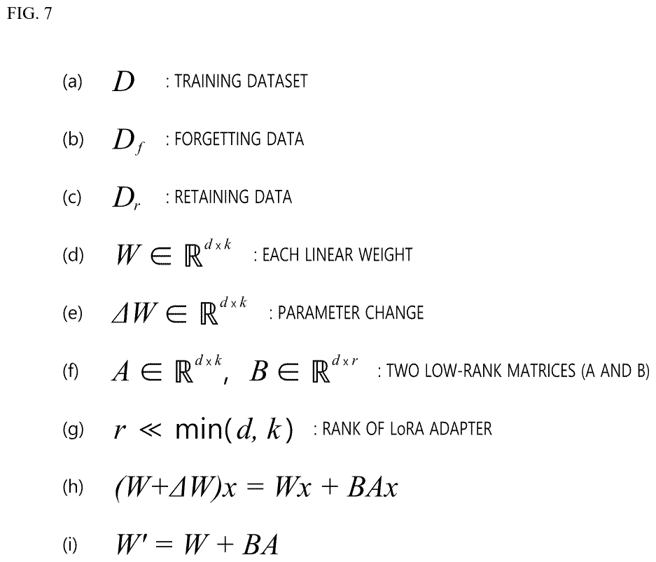

In an embodiment of the present disclosure, the training dataset 200 may be represented as illustrated in (a) of FIG. 7, the forgetting data 210 may be represented as illustrated in (b) of FIG. 7, and the retaining data 220 may be represented as illustrated in (c) of FIG. 7.

Next, in an embodiment of the present disclosure, at step S320 of FIG. 3, by comparing forgetting data and retaining data, an operation of specifying at least one parameter having high importance based on a preset criterion for the forgetting data among parameters of a large language model may be performed. The high importance may mean exceeding a preset reference criterion. In addition, a low importance may mean being relatively lower than parameters having the high importance or being lower than the preset reference criterion or another reference criterion.

Here, the operation of comparing the forgetting data and the retaining data may comprise comparing and analyzing relative importance of parameters for the forgetting data 210 and the retaining data 220.

A parameter may mean a learnable value including weights and biases of a model. The parameters may be adjustable values used when the model learns and predicts (or performs reasoning) data. For example, in an artificial neural network, weights of each layer may be regarded as parameters. Such parameters are optimized through a training process, and through this, the model may learn patterns from data and perform prediction.

The change of parameters (or variables, weights, etc.) due to adaptation of the large language model 150 may essentially have a low-rank (or low-dimensional, low-order, etc.) structure. More specifically, based on an assumption that the change of parameters of the large language model 150 due to adaptation of the large language model 150 has a low-rank, the change may be approximated by low-rank matrices.

Here, the adaptation of the large language model may be a process of altering or adjusting a previously trained model to suit a specific purpose (or task), and may include, for example, training, fine-tuning, unlearning, and the like.

In addition, that the parameter change of the large language model 150 has a low-rank (or low-rank structure) may mean that when parameters (e.g., weight matrices) of the large language model 150 change, the change occurs in a relatively lower-dimensional subspace in the entire parameter space. This may mean that not all weights are altered independently, but the change is made according to a specific low-rank structure. That is, major changes occur not in the entire weight matrix of the large language model 150, but in a specific low-rank (e.g., having a small rank) part. For example, when the model learns data of a specific domain, this may be understood as meaning that not all neurons are equally updated, but only some neurons play a major role.

As described above, assuming that the parameter change due to adaptation of the large language model 150 is low-rank, LoRA (Low-Rank Adaptation) models parameter change of each linear weight (e.g., linear layer weight (or weight matrix) of the large language model 150) as a product of two low-rank matrices. Here, each linear weight may be represented as illustrated in (d) of FIG. 7, and the parameter change may be represented as illustrated in (e) of FIG. 7. In addition, two low-rank matrices A and B may be represented as illustrated in (f) of FIG. 7, and a rank of the LoRA adapter may be represented as illustrated in (g) of FIG. 7. When an input is given to the large language model 150, an output of an adapted linear layer may be represented as illustrated in FIG. (h) of 7.

During the fine-tuning of the large language model 150, existing weights of the pre-trained large language model 150 are fixed, and only the low-rank matrices A and B may be updated through gradient descent. To ensure that the initial attachment of the LoRA adapter does not alter the output of the large language model 150, LoRA defaults to initializing a first low-rank matrix A with a Kaiming-uniform distribution and setting a second low-rank matrix B to a zero matrix. Then, after fine-tuning of the large language model 150 is completed, the LoRA adapter may be merged with existing weights (see (i) of FIG. 7).

The LoRA may be a manner (or technique, method, etc.) of modeling weight matrix change as a product of two low-rank matrices, and updating a model through low-rank change instead of adjusting entire weights. In an embodiment of the present disclosure, without retraining the large language model 150, unlearning for the large language model 150 may be performed in a direction of reducing an amount of operations and increasing efficiency, based on an assumption that parameter change of the large language model 150 mainly occurs in a low-rank region.

In an embodiment of the present disclosure, for each parameter (or weight) of the large language model 150, Fisher information may be measured, and based on the measured result, a weight low-rank decomposition for initializing adapter weights A and B may be performed. In the present disclosure, such a process may also be referred to as “FLoRA (Fisher-weighted LoRA Initialization)”.

In the FLoRA process according to an embodiment of the present disclosure, it is set so that more important parameters for the forgetting data 210 are preferentially adjusted, thereby allowing the large language model 150 to quickly unlearn the forgetting data 210 and aiming to minimize performance degradation for the retaining data 220. To this end, in an embodiment of the present disclosure, parameter importance for each of the forgetting data 210 and the retaining data 220 may be quantified using a Fisher information matrix, and initialization of the large language model 150 may be performed based on this.

The control unit 140 may measure parameter importance for each of the forgetting data 210 and the retaining data 220 using the Fisher information matrix. The control unit 140 may measure how important each weight (or specific weight) of the large language model 150 is for each of the forgetting data 210 and the retaining data 220 using a Fisher information matrix.

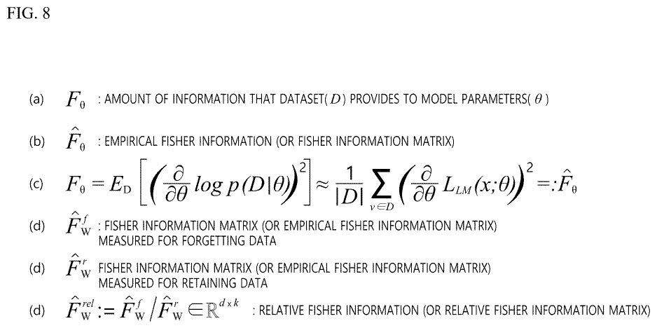

Here, the Fisher information matrix may indicate an amount of information that the training dataset 200 provides to parameters of the large language model 150. The Fisher information matrix may be represented as illustrated in (a) of FIG. 8.

The Fisher information matrix may be calculated as a second central moment of a first partial derivative of a log-likelihood (see left side of (c) of FIG. 8). However, since integrating over a space of the training dataset 200 is computationally impossible, in an embodiment of the present disclosure, empirical Fisher information (or an empirical Fisher information matrix) may be utilized. The empirical Fisher information may be represented as illustrated in (b) of FIG. 8. In case of the large language model, the empirical Fisher information may be calculated as a mean of squares of gradients propagated in a language modeling objective (e.g., cross-entropy loss) (see (c) of FIG. 8). However, in the present disclosure, the terms “Fisher information matrix (or Fisher information)” and “empirical Fisher information matrix (or empirical Fisher information)” may be used interchangeably.

The Fisher information matrix may mean a value indicating how important a specific parameter of the model is in given data. More specifically, the Fisher information matrix may mean a measure (or value) indicating whether at least one parameter (or target parameter, specific parameter, etc.) of the large language model is important for a text sample (e.g., sentence, document, token sequence, paragraph, etc.) included in the forgetting data 210 or the retaining data 220. For example, the Fisher information matrix may serve as a measure indicating whether a specific parameter of the large language model 150 is important for specific data, and the measure representing the importance may be expressed as a gradient.

In this case, a parameter having a large absolute value of a gradient may be specified (or determined, judged, regarded, etc.) as important in the corresponding data. That is, a parameter having a large gradient for specific data may be specified as playing an important role in generating the corresponding data.

Therefore, a parameter having a high absolute value of a gradient for the forgetting data 210 may be specified as having relatively high importance in the forgetting data 210, and a parameter having a high absolute value of a gradient for the retaining data 220 may be specified as having relatively high importance in the retaining data 220.

The control unit 140 may measure a Fisher information matrix for each of the forgetting data 210 and the retaining data 220.

Specifically, the control unit 140 may compute, for each parameter of the large language model 150, a Fisher information matrix for the forgetting data 210 and another Fisher information matrix for the retaining data 220 using the forgetting data 210 and the retaining data 220. The control unit 140 may acquire the Fisher information matrix for the forgetting data 210 measured or calculated using the forgetting data 210 for each parameter of the large language model 150, and the Fisher information matrix for the retaining data 220 measured or calculated using the retaining data 220. Here, the Fisher information matrix measured for the forgetting data 210 may be represented as illustrated in (d) of FIG. 8, and the Fisher information matrix measured for the retaining data 220 may be represented as illustrated in (e) of FIG. 8.

In another embodiment, the control unit 140 may set (or select) at least one target parameter (target) among parameters of the large language model, and may measure or calculate a Fisher information matrix for the forgetting data 210 and a Fisher information matrix for the retaining data 220 for the target parameter using the forgetting data 210 and the retaining data 220. The control unit 140 may acquire the Fisher information matrix for the forgetting data 210 measured or calculated using the forgetting data 210, and the Fisher information matrix for the retaining data 220 measured or calculated using the retaining data 220, for the target parameter. In this case, the target parameter may be set (or selected) randomly, or may be set based on preset criteria (e.g., which may vary, such as a parameter having a high training weight, a parameter having a high generation probability distribution of the forgetting data, etc.).

At step S401 of FIG. 4, the control unit 140 may measure (or analyze, quantify) parameter importance for each of the forgetting data 210 and the retaining data 220 using the Fisher information matrix for the forgetting data 210 and the Fisher information matrix for the retaining data 220.

Here, the parameter importance may be measured or calculated using a relative Fisher information matrix between the Fisher information matrix for the forgetting data 210 and the Fisher information matrix for the retaining data 220. The control unit 140 may preferentially specify (or select, identify, etc.) parameters that have high importance in the forgetting data 210, but low importance in the retaining data 220, using the relative Fisher information matrix between the forgetting data 210 and the retaining data 220 as an importance index. The relative Fisher information matrix may be represented as illustrated in (f) of FIG. 8.

The relative Fisher information matrix may be calculated using the Fisher information matrix for the forgetting data 210 and the Fisher information matrix for the retaining data 220. In this case, calculating the relative Fisher information matrix may also be understood as calculating relative importance of parameters for the forgetting data 210 and the retaining data 220.

The control unit 140 may calculate a relative Fisher information matrix between the Fisher information matrix measured or calculated for each of the forgetting data 210 and the retaining data 220, and may measure (or analyze, quantify) parameter importance for each parameter of the large language model 150 based on the calculated result.

As a result of measurement or calculation of parameter importance, the control unit 140 may specify (or determine, select, etc.) at least one parameter, having a high Fisher information matrix measured for the forgetting data 210, among parameters of the large language model 150, as a specific parameter. At step S402 of FIG. 4, the control unit 140 may specify a parameter having high parameter importance for the forgetting data 210 as a specific parameter. The specific parameter may be a parameter having a large absolute value of a gradient for the forgetting data 210, and having relatively high importance in the forgetting data 210.

That is, in an unlearning process according to the present disclosure, high Fisher information for the forgetting data 210 may indicate that a next-token prediction loss in the forgetting data 210 induces a large absolute gradient at the corresponding parameter. Therefore, in an embodiment of the present disclosure, the parameter may be specified as a specific parameter important for generating a sequence of the forgetting data 210. In the present disclosure, the specific parameter may also be referred to as a “specific weight”, an “important parameter”, or an “important weight”.

In another embodiment, the control unit 140 may calculate a relative Fisher information matrix between the Fisher information matrix for the forgetting data 210 and the Fisher information matrix for the retaining data 220, which are calculated or measured for a target parameter, and may measure (or analyze), based on the calculated result, for which data the target parameter has higher importance. As a result of the calculation or measurement of importance of the target parameter, the control unit 140 may specify the target parameter as a specific parameter when the target parameter has high importance for the forgetting data 210. In contrast, as a result of the calculation or measurement of importance of the target parameter, the control unit 140 may exclude the target parameter from initialization target when the target parameter has high importance for the retaining data 220, and may re-perform the above-described process for specifying a parameter having high importance for the forgetting data 210.

Accordingly, the control unit 140 may identify or specify, as a specific parameter, a parameter among parameters of the large language model 150, having relatively high Fisher information for the forgetting data 210 compared to the Fisher information for the retaining data 220. For example, the control unit 140 may preferentially identify or specify a specific parameter having high Fisher information for the forgetting data 210 but low Fisher information for the retaining data 220.

That is, the control unit 140 may compare the forgetting data (e.g., Fisher information for the forgetting data) and the retaining data (e.g., Fisher information for the retaining data), and identify or specify, as a specific parameter to be set to be preferentially adjusted in the unlearning process, a parameter having high (or important) importance for the forgetting data 210 and low (or unimportant) importance for the retaining data 220.

In an embodiment of the present disclosure, at step S330 of FIG. 3, based on the specific parameter having high importance for the forgetting data, an operation of initializing a weight of LoRA (Low-Rank Adaptation) may be performed.

In an embodiment of the present disclosure, the initialization operation may be an operation of calculating relative importance of parameters for the forgetting data 210 and the retaining data 220, and performing LoRA initialization based on a calculated result. In addition, the initialization operation may be a process of initializing weights A and B of LoRA so that parameters important for the forgetting data 210 become larger.

In addition, the initialization operation may be an operation of initializing weights A and B of a LoRA adapter based on a specific parameter having high importance for the forgetting data 210, so that the unlearning process is performed centered on the specified parameter, thereby allowing the corresponding weights to focus on removal of knowledge of the forgetting data 210.

In addition, the initialization operation may be an operation of applying the LoRA to the specific parameter having high importance for the forgetting data 210 (e.g., decomposing the specific parameter into adapter weights A and B of the LoRA), and initializing the weights A and B of the LoRA by reflecting information (e.g., Fisher information, relative Fisher information, etc.) for the specific parameter. For example, existing weights W of the pre-trained large language model 150 are fixed so that an output of the model is not changed when the LoRA is applied.

In addition, the initialization operation may be an operation of initializing a weight of the LoRA (e.g., a weight of an LoRA adapter) based on importance (e.g., importance information) of the specific parameter having high importance for the forgetting data 210, so that knowledge for the forgetting data 210 is effectively removed.

In addition, the initialization operation may be an operation of initializing weights (e.g., low-rank matrices) of the LoRA so that importance of the specific parameter having high importance for the forgetting data 210 is reflected. In addition, the initialization operation may be an operation of initializing a weight of LoRA based on relative importance of the specific parameter having high importance for the forgetting data 210, thereby inducing unlearning to be quickly and efficiently performed centered on the specified parameter through adjustment for the corresponding parameter.

In addition, the initialization operation may be an operation of initializing low-rank matrices A and B of the LoRA adapter (i.e., LoRA) in a direction reflecting importance of the specific parameter having high importance for the forgetting data 210, so that the unlearning is effectively performed (In an embodiment, weights of the pre-trained large language model may be fixed).

At step S403 of FIG. 4, the control unit 140 may initialize a weight of the LoRA, centered on the specific parameter having high importance in the forgetting data 210.

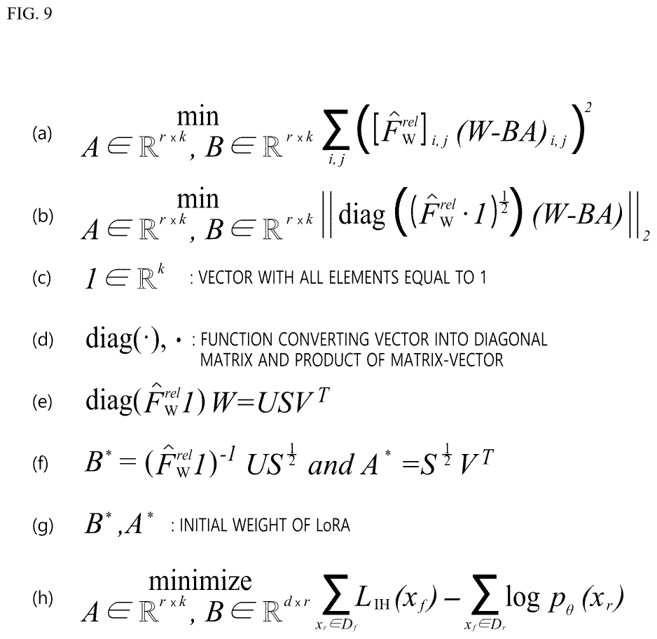

In one embodiment, when the weight of the LoRA is initialized with parameters important for generating the forgetting data 210, only parameters important for the forgetting data 210 are modified by a gradient, and remaining parameters are retained, which may be advantageous in the unlearning process. When relative importance for each parameter of the large language model 150 is given, a solution of a weighted low-rank approximation (WLRA) problem may be represented as initialization of a weight of the LoRA adapter. This may be represented as illustrated in (a) of FIG. 9.

In this case, in the present disclosure, it may be assumed that parameters of each row of the large language model 150 have the same importance, and a weighted low-rank approximation problem may be redefined using a square root of a row-wise sum of a relative Fisher information matrix. This may be represented as illustrated in (b) of FIG. 9.

Here, a vector in which all elements are 1 may be represented as illustrated in (c) of FIG. 9, and a function for converting the vector into a diagonal matrix and a product of matrix-vector may be represented as illustrated in (d) of FIG. 9. As such, a row-wise weighted low-rank approximation (or Fisher information-based weighted low-dimensional approximation) problem may have a closed-form solution, and as illustrated in (e) of FIG. 9, the solution may be calculated by applying a singular value decomposition (SVD) of rank (r). In this case, optimal low-rank matrices A and B in an embodiment of the present disclosure may be calculated as illustrated in (f) of FIG. 9.

Here, the solution may include an optimal weight of LoRA acquired by low-rank approximating existing model weights W including important information in the forgetting data 210. For example, the solution may be a low-rank approximation solution of a weight matrix having high importance for the forgetting data 210 but low importance for the retaining data 220.

After calculating the solution, the control unit 140 may use the calculated optimal low-dimensional matrix as an initial weight of LoRA (see (g) of FIG. 9). After the LoRA initialization, the control unit 140 may update a layer of the large language model 150 so that an output of the large language model 150 cannot be distorted. That is, the unlearning system 100 may extract a specific parameter important for the forgetting data 210 but not important for the retaining data 220, so that the LoRA tuning can be focused on removing knowledge for the forgetting data 210.

As such, in the initialization operation according to an embodiment of the present disclosure, among the forgetting data 210 and the retaining data 220, important information for the forgetting data 210 may be specified and reflected in the initialization operation. As described above, in an embodiment of the present disclosure, a Fisher information-based weighted low-rank approximation may be performed so that only specific parameters important for the forgetting data 210 can be reflected in low-rank matrices of the LoRA. The control unit 140 may apply Fisher information-based weighted low-rank approximation, and initialize matrices A and B of the LoRA by selecting parameters including relatively important information in the forgetting data 210, thereby allowing the learning of information to be deleted to be performed faster and more precisely.

In an embodiment of the present disclosure, at S340 of FIG. 3, an operation of performing unlearning for the large language model to which a weight of the LoRA is applied may be performed.

The control unit 140 may perform the unlearning for the large language model 150 based on the result of performing the initialization of the weight of LoRA. That is, after the initialization operation is completed, the unlearning may be performed in the large language model 150 to which the initialized weight of LoRA is applied.

In this case, while the unlearning is performed in the large language model 150, parameters of the pre-trained large language model 150 are fixed, and only a weight of the LoRA may be updated. In this case, in the process of performing unlearning for the forgetting data 210, a set of retaining data 220 including general knowledge may be used together.

The control unit 140 may perform the unlearning for the large language model 150 using a preset loss function so as to effectively remove data (i.e., forgetting data) to be removed, and increase efficiency for data (i.e., retaining data) to be retained. For example, in an embodiment of the present disclosure, the preset loss function for the unlearning of the large language model 150 may be a final loss function using Inverted Hinge Loss (IHL). Such a loss function may be represented as illustrated in (h) of FIG. 9.

The unlearning of the large language model 150 may be performed in a direction of minimizing the final loss function through probabilistic gradient descent with backpropagation by sampling text corpora (or data) from each dataset.

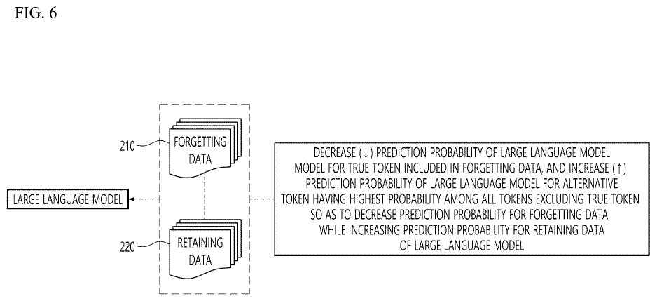

Specifically, as illustrated in FIG. 6, at S404 of FIG. 4, the large language model 150 may perform the unlearning for the forgetting data 210 using the preset loss function. In this case, while increasing a prediction probability for the retaining data 220 of the large language model 150, the control unit 140 may perform the unlearning for the large language model using the loss function so that a prediction probability for the forgetting data 210 can be decreased. That is, the control unit 140 may perform the unlearning for the large language model 150 using the loss function so that knowledge for data to be retained (i.e., retaining data) can be retained, while data to be removed (i.e., forgetting data) can be efficiently removed, without affecting reasoning ability and generation ability of the large language model 150.

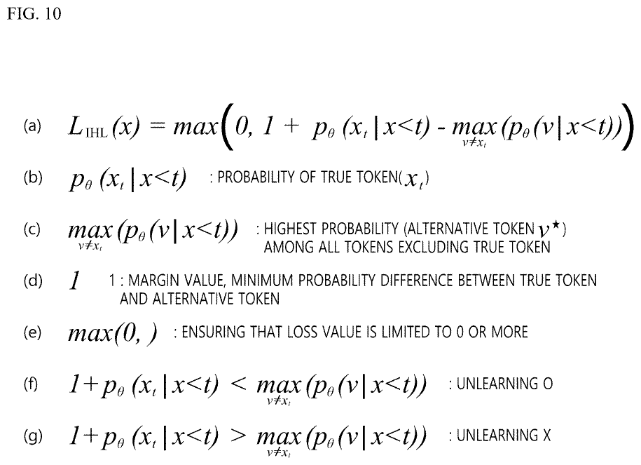

As described above, in an embodiment of the present disclosure, while reducing a prediction score for an actual token (or true token), only prediction scores for a small number of other tokens are increased, thereby performing unlearning effectively. To this end, the Inverted Hinge Loss used in the preset loss function in the present disclosure may be represented as illustrated in (a) of FIG. 10.

First, the control unit 140 may perform the unlearning for the large language model 150 using the loss function in a direction of decreasing a prediction probability (or prediction score) for the forgetting data 210, so that the large language model 150 removes (or does not generate, recognize, perform reasoning, etc.) knowledge for the forgetting data 210.

More specifically, the control unit 140 may adjust a probability distribution of the large language model 150 in a direction of decreasing a prediction probability for the true token included in the forgetting data 210, so that a prediction probability for the forgetting data 210 of the large language model 150 is decreased (see FIG. 6). A probability of the true token may be represented as illustrated in (b) of FIG. 10.

In addition, the control unit 140 may maximize a log probability for the retaining data 220 using the loss function so that the large language model 150 retains knowledge for the retaining data 220 (or retains ability to generate (or recognize, perform reasoning, etc.) the retaining data 220). For example, the control unit 140, in order to retain (or increase) ability of the large language model 150 to generate the retaining data 220, may maximize a log probability for the retaining data 220, and adjust balance so that the model cannot perform forgetting more than necessary.

More specifically, the control unit 140 may adjust a probability distribution of the large language model 150 in a direction of increasing a prediction probability for an alternative token having the highest probability among all tokens except the true token, so that the large language model 150 retains ability to generate the retaining data 220 (see FIG. 6). Here, the alternative token may correspond to one token having a highest possibility of replacing the true token among all tokens excluding the true token. Such an alternative token may be represented as illustrated in (c) of FIG. 10.

In addition, all tokens may be remaining tokens excluding the true token among tokens included in a vocabulary set of the pre-trained large language model 150, and for example, the vocabulary set may mean a set of words or sub-word units that the model may use. In another example, all tokens may include at least one among tokens included in the retaining data 220 set.

Such a minimum probability difference between the true token and the alternative token may be represented as illustrated in (d) of FIG. 10, and ensuring that a loss value is limited to be not less than 0 may be represented as illustrated in (e) of FIG. 10. The Inverted Hinge Loss (e.g., (a) of FIG. 10) used in the preset loss function according to an embodiment of the present disclosure may converge the loss to 0 when a probability of the true token becomes sufficiently smaller than that of the alternative token having the highest replaceability (e.g., when the unlearning is completed). In this case, a case where the unlearning is completed may be represented as illustrated in (f) of FIG. 10, and a case where the unlearning is not yet completed may be represented as illustrated in (g) of FIG. 10.

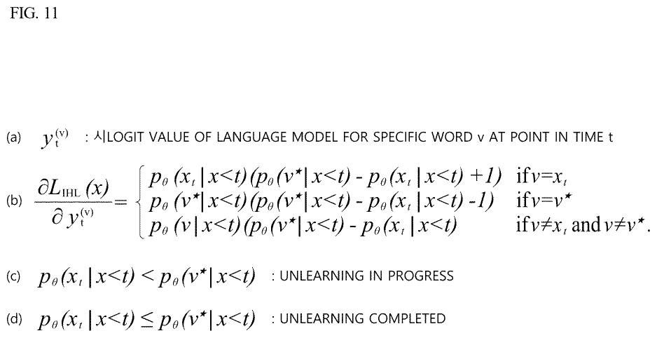

In one embodiment, considering a probability of the true token defined through a softmax function, a derivative of the Inverted Hinge Loss with respect to a logit value of a specific word v at a point in time t of the large language model (see (a) of FIG. 11) may be represented as illustrated in (b) of FIG. 11.

In addition, in a gradient calculation operation of the Inverted Hinge Loss, when the unlearning is in progress (see (c) of FIG. 11), a probability of the true token may be decreased and a probability of the alternative token may be increased. In this case, since an absolute value of the gradient is greater than or equal to that of the alternative token, a probability of the true token may decrease more rapidly. Although adjustment is made in a direction of increasing the probability of the alternative token, the probability of the alternative token may be increased more slowly than the probability of the true token (since the absolute value of the gradient of the alternative token is smaller than that of the true token). Further, other tokens may be slowly increased in probability in proportion to a probability difference between the true token and the alternative token.

Furthermore, in a gradient calculation operation of the Inverted Hinge Loss, in a case where the unlearning is completed (see (d) of FIG. 11), when a value of “a difference between a probability of the true token and a probability of the alternative token +1” is smaller than 0, the loss may converge to 0.

That is, in an embodiment of the present disclosure, while decreasing a probability of the true token and increasing a probability of the alternative token, when the unlearning of the large language model 150 for the forgetting data 210 is completed, the loss may converge to 0 to stably terminate the unlearning process. Through this, gradient updates may be efficiently performed without affecting reasoning ability and generation ability of the large language model 150.

Meanwhile, as described above, an embodiment of the present disclosure may be applied to various industries and services to be usefully utilized. An embodiment of the present disclosure may be applied to and usefully utilized in at least one among opt-out applications, natural language generation-related services, conversational AI and chatbots, text generation AI and content generation, personalized education and language learning, social media and online platforms, harmful content filtering, medical and healthcare, finance and law, and games and virtual environments.

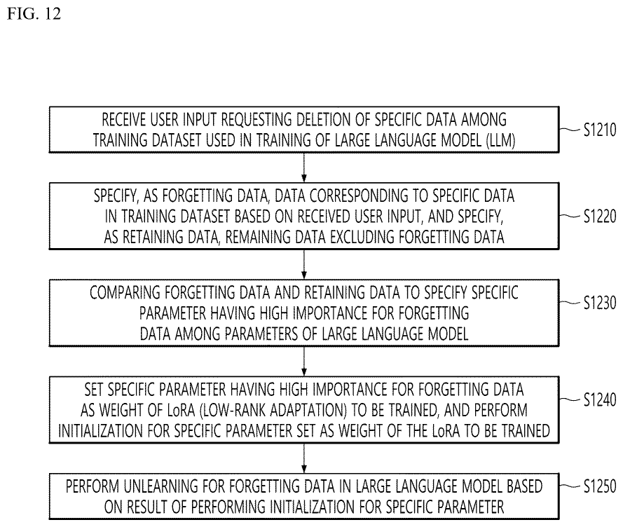

Referring to FIG. 12, a method and system for unlearning of a large language model according to an embodiment of the present disclosure may include: a step S1210 of receiving a user input requesting deletion of specific data among a training dataset used in training of the large language model (LLM) at an inference stage; a step S1220 of specifying data corresponding to the specific data in the training dataset as forgetting data based on the received user input, and specifying remaining data excluding the forgetting data as retaining data; a step S1230 of specifying a specific parameter having high importance for the forgetting data among parameters of the large language model by comparing the forgetting data and the retaining data; a step S1240 of initializing a weight of Low-Rank Adaptation (LoRA) based on the specific parameter having high importance for the forgetting data; and a step S1250 of performing unlearning for the large language model to which the weight of the LoRA is applied.

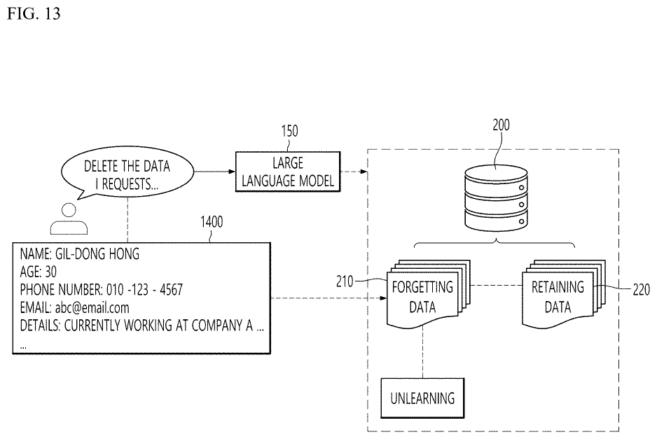

As illustrated in FIG. 13, the control unit 140 may receive a user input (e.g., “delete the data I requested . . . ”) requesting deletion of specific data 1400 in the training dataset 200 used in the training of the large language model 150, from the user terminal 10. The user input may be received through various manners. For example, the user input may be received through various manners such as selection of specific data by a user through a user interface, text query input of the user for specific data to be deleted, voice input of the user for specific data to be deleted, or the like, and is not necessarily limited to the above-described cases.

The control unit 140 may analyze specific data corresponding to a received user input, and based on the analyzed result, may specify data corresponding to specific data 1400 among the training dataset 200 used in training of the large language model 150 as the forgetting data 210. In addition, the control unit 140 may specify remaining data excluding the forgetting data 210 as the retaining data 220.

When the forgetting data 210 and the retaining data 220 are specified, the control unit 140, for each parameter of the large language model 150, may calculate or measure a Fisher information matrix for the forgetting data 210 and a Fisher information matrix for the retaining data 220 using the forgetting data 210 and the retaining data 220. Based on the calculated or measured result, the control unit 140 may acquire the Fisher information matrix for the forgetting data 210 measured using the forgetting data 210, and the Fisher information matrix for the retaining data 220 measured using the retaining data 220. Furthermore, the control unit 140 may measure (or analyze, quantify) parameter importance using the acquired Fisher information matrix for the forgetting data 210 and the Fisher information matrix for the retaining data 220. As a result of measurement of parameter importance, the control unit 140 may specify, as a specific parameter, a parameter having high parameter importance for the forgetting data while having low importance for the retaining data 220.

Finally, the control unit 140 may initialize a weight of Low-Rank Adaptation (LoRA) based on the specific parameter having high importance for the forgetting data. The control unit 140 may perform the unlearning for the large language model 150 to which a weight of LoRA is applied. More specifically, the control unit 140 may the perform unlearning for the large language model using the loss function so that a prediction probability for the forgetting data 210 is decreased, while increasing a prediction probability for the retaining data 220 of the large language model 150. Decreasing a prediction probability of the large language model 150 for the true token included in the forgetting data, and increasing a prediction probability of the large language model 150 for an alternative token having the highest probability among all tokens excluding the true token may decrease a prediction probability for the forgetting data 210.

Furthermore, when the unlearning for the forgetting data 210 is completed, whether the forgetting of the forgetting data 210 of the large language model 150 is performed may be determined (or judged). The determination of whether forgetting is performed may be determined according to various criteria. For example, whether the forgetting of the forgetting data 210 is performed may be autonomously determined based on preset criteria (e.g., user history information, user personal information (e.g., name, address, phone number, email, etc.), criteria set in relation to copyright infringement elements, etc.) by an administrator or a user of the unlearning system 100 or an artificial intelligence model 160.

In one embodiment, in order to identify whether the forgetting of the forgetting data 210 is performed, a query related to the forgetting data 210 may be input to the large language model 150. When the unlearning for knowledge of the forgetting data 210 is completed, the large language model 150 may provide an answer to a user indicating that the unlearning for the forgetting data 210 is completed.

As such, the unlearning system 100 may delete knowledge for specific data 1400 requested to be deleted by the user, and may retain knowledge for data to be retained. That is, the unlearning system 100 may delete knowledge for the specific data 1400 corresponding to a deletion request of the user from a training result of the large language model 150, and may efficiently retain knowledge for the retaining data 220 to be retained in the training result.

According to another embodiment of the present disclosure, a method and system for optimizing a large language model, and a method for controlling a large language model optimization system may improve learning efficiency for the large language model. More specifically, a method and system for optimizing a large language model may improve learning speed and reasoning speed (or performance) of the large language model, and achieve cost-efficient learning. Further, a method and system for optimizing a large language model may effectively remove data to be removed and increase efficiency for data to be retained. Some embodiments of the method and system for unlearning of a large language model, and the method for controlling an unlearning system of a large language model described above may also be a method and system for optimizing a large language model and a method for controlling a large language model optimization system.

The large language model (LLM) may have strong reasoning ability and memory ability through pre-training on a vast amount of text data. However, the large language model (LLM) may be exposed to a risk of personal information protection and copyright infringement in a process of learning text provided by a human.

In order to prevent this, according to some embodiments of the present disclosure, unlearning for removing sensitive data (i.e., data to be removed) including, for example, but not limited to, information having a risk of personal information protection and copyright infringement (hereinafter “unlearning”) may be performed. For instance, the unlearning may include a process of intentionally removing (or deleting) or modifying information or patterns (or knowledge) that a model has previously (or in advance) learned. For example, the unlearning may comprise a method of removing or modifying the learned content when a model has learned incorrect information, inappropriate bias, or unintended data.

Referring to FIG. 1, of the unlearning of a large language model may be performed to fine-tune a pre-trained large language model so as to remove or delete knowledge regarding a dataset to be removed (e.g., “Forget set”). For example, a dataset to be removed, forgotten, or deleted may include text data requested to be deleted from a user. In the operation of the unlearning, the large language model may be required to forget knowledge regarding data included in a dataset to be removed, and to retain knowledge regarding data included in a dataset to be retained (e.g., “Retain set”), and also to retain reasoning ability and generation ability previously acquired.

Accordingly, certain embodiments of the present disclosure may provide a method and system for optimizing a large language model to efficiently remove data to be removed while retaining knowledge regarding data to be retained, without affecting reasoning ability and generation ability of the large language model.

Some embodiments of the present disclosure may be usefully utilized in various situations. More specifically, according to some embodiments of the present disclosure, a method and system for optimizing a large language model may be applied to various industries and services, and may be usefully utilized. For example, a method and system for optimizing a large language model according to certain embodiments of the present disclosure may be applied to a system, application, software, web-site, program, etc. based on a language model (e.g. a large language model), and may be usefully utilized.

Accordingly, certain embodiments of the present disclosure may be usefully utilized in various industries and services requiring training and/or unlearning of a large language model (e.g., natural language generation related services, conversational AI and chatbot, text generation AI and content generation, customized education and language learning, social media and online platforms, harmful content filtering, medical and healthcare, finance and law, game and virtual environment, etc.).

Referring to FIG. 2, a system 100 for large language model optimization (hereinafter, referred to as “optimization system”) according to the present disclosure may include at least one of an input unit 110, an output unit 120, a storage unit 130, a control unit or controller 140, or a large language model 150.

The optimization system 100 according to an embodiment of the present disclosure may include at least one processor and at least one memory including a computer program code and/or executable instructions which can be executed by at least one processor. The storage unit 130 may serve as the memory. The memory and the program code may cooperate with the processor to perform a series of operations or processes described below.

The optimization system 100 according to an embodiment of the present disclosure may include one or more processors. The processor may include one or more general-purpose processors and/or one or more special-purpose processors (for example, a digital signal processor, a tensor processing unit (TPU), a graphics processing unit (GPU), a neural processing unit (NPU), an application-specific integrated circuit, an application-specific integrated circuit (ASIC), a field programmable gate array (FPGA), a quantum processing device (or quantum processor, QPU), etc.). The processor may be configured to execute instructions, computer-readable directives, and/or any other instructions which are stored or included in the storage unit 130. The method and system for optimizing the large language model according to the present disclosure may process data by cooperation between a memory and at least one processor. The processor may perform a series of operations and data processing using data, instructions, and information stored in the memory. The memory may be configured to be the storage unit 130.

In addition, the optimization system 100 according to an embodiment of the present disclosure may perform data processing and computation using a quantum gate, quantum entanglement, and a quantum superposition state, in consideration of implementation in a quantum computer environment. For example, certain embodiment of the present disclosure may perform parallel operation based on qubits, and such quantum operations may operate complementarily with a conventional classical computer.

In the quantum computer, a high-speed data processing device that utilizes parallel operation using qubits and quantum entanglement may be included, and hardware-based operation optimization using an FPGA and an ASIC may be performed. In addition, in the quantum computer, a quantum processor capable of performing parallel operation based on qubits may be used, and data processing efficiency may be improved through a hybrid structure with a computer.

The input unit 110 may be configured to input data, and may be configured in various types. For example, the input unit 110 may be configured to receive an input from a user. For example, the input unit 110 may be configured to receive user input from the user terminal 10. For example, the operation of receiving an input may comprise an operation of receiving an input signal or selection signal corresponding to the user input, based on the input being made by the user through input unit configuration provided in the user terminal 10.

The user terminal 10 may include, for example, but not limited to, a cell phone, a smart phone, a notebook computer, a portable computer, a laptop computer, a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), and a head mounted display (HMD)).

In addition, in an embodiment of the present disclosure, the input unit 110 may not be a hardware means, but may be a channel for receiving input from a user.

The input unit 110 may include a user interface module. The input unit 110 may include a touch screen, computer mouse, keyboard, keypad, touch pad, trackball, joystick, voice recognition module, or other similar devices. However, in the present disclosure, the types of the input unit 110 are not limited thereto.

Here, the user input may include, for instance, but not limited to, a document, text, image or video, voice, and the like. The optimization system 100 may further include a module for converting voice into text.

The output unit 120 may output information through an output unit configuration (e.g., a display unit, touch screen, speaker, etc.) provided in the user terminal 10 operably associated with the optimization system 100 according to an embodiment of the present disclosure. For example, the output unit 120 may output a page (e.g., a service page) linked with the optimization system 100 according to an embodiment of the present disclosure to a display unit of the user terminal 10. In addition, the output unit 120 may not be a hardware means, but may be a channel for outputting results to a user.

The storage unit 130 (such as a memory) may store various data related to the present disclosure. The storage unit 130 may include one or more non-transitory computer-readable storage media that may be read and/or accessed or retrieved by at least one processor.

The computer-readable storage media may include volatile and/or non-volatile storage constituent elements, such as optical, magnetic, organic, or other memory or disk storage devices. In some embodiments, the storage unit 130 may be implemented as a single physical device (e.g., one optical, magnetic, organic, or other memory or disk storage device). However, in other embodiments, the storage unit 130 may be implemented as the plurality of physical devices.

The storage unit 130 may include computer-readable directives and additional data. The storage unit 130 may include storage necessary to perform at least part of one or more operations, methods, scenarios, and technologies and/or at least part of one or more functions of the devices and networks described in the present disclosure.

Further, at least a part of the storage unit 130 may be implemented as a cloud storage or a cloud server. At least a part of data corresponding to the user input received from the input unit 110, training data or training dataset 200 may be stored in the storage unit 130.

The storage unit 130 may have a sufficient space where information necessary for the operation of the optimization system 100 is stored, and it may be understood that there are no constraints on physical space.

Further, the storage unit 130 may store a computer program and instructions for the computer program. Further, the storage unit 130 may store a computer program and computer program instructions that, when loaded to or executed by a processor of the system 100, control operation of the system 100 or operation of the control unit 140.

Next, the control unit 140 may be configured to control overall operation of the optimization system 100. The control unit 140 may process signals, data, instructions, information, and the like that are input or output through the constituent elements of the optimization system 100 described above, or perform a series of data processing to provide or process appropriate information and functions to the user. For instance, the control unit 140 may be physically implemented as a processor described above.

Meanwhile, the large language model 150 may be a pre-trained (or previously trained) model using the training dataset 200. The large language model 150 may perform pre-training on large-scale text data (or a text corpus, text data, text samples, text sequences, token sequences, language data, etc.) included (or configured) in the training dataset 200. The large language model 150 may model a likelihood of a sequence through next-token prediction when a token sequence (or text sequence) of a predetermined length (T) is given.

The large language model 150 according to the present disclosure may be configured based on various structures. For example, the large language model 150 according to the present disclosure may be a transformer-based model. Such a transformer may be configured in an encoder-decoder structure that receives, as input, an input sequence in an encoder and outputs an output sequence in a decoder.

Here, a structure of the transformer may be largely configured with positional encoding, multi-head attention, and a feed-forward network (FFN). The positional encoding generates a vector for each position so that the model may recognize order information of input tokens, and adds it to a token embedding, thereby allowing the transformer to consider position information even without a sequential structure. The multi-head attention is a structure that calculates relationships between respective tokens in parallel in multiple attention heads. Each head multiplies the input embeddings by query (Q), key (K), and value (V) matrices to calculate attention, and combines the results to richly reflect overall contextual information. The feed-forward network is a multi-layer perceptron (MLP) applied independently to each token, and generates outputs to be delivered to a next transformer layer by processing attention results.

In another embodiment, the large language model 150 according to the present disclosure may be a mixture of experts (MoE)-based model. The mixture of experts (MoE) is an efficient model architecture in which a plurality of experts (or models) are combined to perform a specific task, where each expert is a model specialized in solving a given problem, and may be configured with a structure including a gate for determining which expert to select among multiple experts. More specifically, the mixture of experts (MoE) may be understood as a manner of configuring multiple models (experts), each expert being trained to specialize in a specific task, and then selectively activating only experts specialized in the specific task, thereby reducing operation cost and improving calculation (or operation) efficiency and performance of the model.

Here, an expert is an independent model, and each expert has a separate parameter set, and each expert performs specialized learning for a specific type of task. In addition, a gate (or gate network) plays a role of determining which expert to select based on input data. The gate calculates a probability distribution of an expert to be selected among multiple experts using a softmax function, and selects a most suitable expert according to the calculated probability. Further, results output by each expert may be weightedly summed according to a probability calculated in the gate, and a final output may be determined. Outputs of selected experts may be combined with weights assigned according to probability values.

For example, experts included in a mixture of experts (MoE)-based large language model 150 may variously exist, such as an expert specialized in natural language processing tasks, an expert specialized in voice data processing, an expert specialized in image processing, and the like.

In another embodiment, in the present disclosure, the large language model 150 may be trained using a pipeline parallelism technique. The large language model 150 may be a model trained through pipeline parallelism. The pipeline parallelism may be a distributed training technique that, when training or performing reasoning with a large deep learning model, divides operations of the model into layer units over multiple devices (e.g., GPUs) and processes them in parallel.

In the present disclosure, based on the pipeline parallelism technique, operations of the large language model 150 may be divided into a plurality of processing steps (e.g., layers or modules), and each step may be processed in parallel. That is, in the present disclosure, layers of the large language model may be sequentially processed by multiple processing devices (e.g., GPUs), thereby reducing bottlenecks and improving processing efficiency. Such pipeline parallelism, while one input is processed, allows each device to also perform operations for a next input, thereby more efficiently utilizing calculation resources. Through this, memory capacity may be saved, and a speed and efficiency of training of the large language model 150 may be increased. In addition, by utilizing multiple GPUs, resources of each GPU may be optimally used, thereby increasing utilization of GPUs and reducing waste of resources.

Further, the large language model 150 according to the present disclosure may be a pre-trained and/or fine-tuned model using at least one of supervised learning, reinforcement learning, or supervised fine-tuning.

The large language model 150 trained in the present disclosure may correspond to at least one of a large language model based on supervised learning, a large language model 150 based on reinforcement learning, or a large language model 150 adjusted through supervised fine-tuning.

The supervised learning may be a manner of training a model based on input data and ground truth labels (outputs) corresponding thereto. More specifically, the supervised learning may be training a model using input-output pairs (labeled data), and in a training process, input data and corresponding ground truth (labels) are given, and the model may learn patterns based thereon to perform prediction for new data. For example, the supervised learning may include regression and classification problems, and may serve as supervision for predicting output values based on training data.

The reinforcement learning is a process in which an agent learns a policy for maximizing a reward while interacting with an environment. The reinforcement learning is mainly used to solve sequential decision-making problems, and the agent selects an action according to a state, receives a reward as a result of the action, and proceeds with learning based thereon. Here, the agent makes a decision based on information obtained by interacting with the environment, and the environment provides feedback (reward) therefor. The agent improves its behavior in a direction of maximizing long-term rewards.

For example, when the large language model 150 is trained based on reinforcement learning in the present disclosure, it may be reinforcement-learned using at least one of a Proximal Policy Optimization (PPO) algorithm and/or reinforcement learning centered on reasoning.

Here, the Proximal Policy Optimization (PPO) is one of efficient and stable algorithms for policy optimization in reinforcement learning, and is configured based on a policy gradient technique. A main objective of such Proximal Policy Optimization (PPO) is to optimize parameters of a policy (i.e., an action selection probability distribution) so as to maximize rewards in a given environment.

After pre-training of the large language model 150 is completed, it is assumed that a user has requested to delete specific data (or a specific dataset) from the training dataset 200 used in training of the large language model 150. In the present disclosure, specific data that a user wants to remove (perform unlearning) may be referred to as “forgetting data” or “forgetting dataset”. In addition, in the present disclosure, even after unlearning of the forgetting data 210 is completed, data including knowledge that the large language model 150 must not remove, forget, or unlearn may be referred to as “retaining data” or “retaining dataset”.

In this case, in an unlearning process, by maximizing next-token prediction loss of at least one text sequence included in the forgetting data 210, the large language model 150 may unlearn the text sequence, in order to assign a low probability to the forgetting data 210.

Here, maximizing the prediction loss may mean maximizing the next-token prediction loss through gradient ascent, which is opposite to gradient descent. Unlike gradient descent (or steepest descent, gradient descent method, etc.), which increases prediction probability (or prediction score, generation probability, generation score, etc.) for a ground truth of the model by minimizing a loss function, gradient ascent (or steepest ascent, gradient ascent method) decreases prediction probability for a ground truth by maximizing a loss function. In relation thereto, a log-likelihood may be implemented as a cross-entropy loss for incremental tokens. The gradient ascent may adjust the model to maximize the cross-entropy loss.

As such, the above-described gradient ascent causes the model to be trained in a direction that reduces a probability assigned a true token while increasing probabilities of remaining tokens. That is, the model is to be trained to increase the probabilities of all tokens other than the ground truth token.

Therefore, maximizing a prediction loss may mean adjusting a probability distribution of the large language model to induce the large language model 150 not to learn or not to predict a specific text sequence. For example, in order for the large language model 150 to predict specific tokens, which have been predicted with high probability, with lower probability, by maximizing the prediction loss for the specific tokens to decrease prediction probability for the specific tokens, the large language model 150 may adjust the probability distribution so as to perform inaccurate prediction regarding the specific tokens (i.e., suppression of generation of forgetting data, suppression of generation of inappropriate sentence, etc.).

However, in the present disclosure, in order to prevent i) a loss not converging and increasing or diverging without a finite boundary, ii) unnecessary additional forgetting occurring by increase of logits for all other tokens, or iii) unstable results occurring in an optimization process, the probability distribution of the model is adjusted in a direction of decreasing prediction probability for a true token while not increasing prediction probability for all tokens other than the true token, and increasing prediction probability (e.g., a loss function) for the token (alternative token) having the highest probability among all tokens other than the true token. That is, in an embodiment of the present disclosure, a method of adjusting the model by concentrating gradient updates only on a minimum number of alternative tokens having high replaceability of a true token is used. More detailed description thereof will be described later.

According to an embodiment of the present disclosure, a method for controlling a large language model optimization system may improve learn efficiency for a large language model. More specifically, according to an embodiment of the present disclosure, a method and system for optimizing a large language model may improve learning speed and reasoning speed or performance of the large language model, and achieve cost-efficient learning. Further, according to an embodiment of the present disclosure, a method and system for optimizing a large language model may effectively remove data to be removed and increase efficiency for data to be retained, and hereinafter, a method for optimizing a large language model according to an embodiment of the present disclosure will be described in more detail.

In an embodiment of the present disclosure, a process of specifying a training dataset, training a large language model (LLM) using the specified training dataset, and acquiring a large language model trained with the training dataset based on the training may be performed.

The control unit 140 may specify a training dataset to be used in the training of the large language model 150. In the present disclosure, a method (or manner, criterion, etc.) of specifying the training dataset (or training data) may vary.

For instance, the control unit 150 may specify specific data corresponding to user input as training data to be used in the training of the large language model 150, based on the input of the user for specific data.

In another example, the control unit 150 may collect data from various sources (e.g., databases, web crawling, APIs, servers interoperated with the optimization system 100, external servers, etc.) and may store the collected data in the storage unit 130. Further, the control unit 150 may specify at least a part of the data stored in the storage unit 130 as training data to be used in the training of the large language model 150.

However, in the present disclosure, a manner of specifying the training dataset 200 is not limited only to the above-mentioned examples, and may also be specified by various manners in addition to or other than the above-mentioned examples.

The training dataset 200 may include various data. For example, the training dataset 200 may include at least one of large-scale supervised learning (SL) data, large-scale reinforcement learning (RL) data, language understanding and reasoning-related data, question and answer data, reading comprehension data, instruction interpretation data, language modeling data, language data of various countries, mathematics data, science data, code (or coding) data, or learning prompts (prompt, or learning or templates).

Based on the specified training dataset 200, the control unit 150 may train the large language model 150 to be trained using the specified training dataset 200. The control unit 150 may process the specified training dataset 200 as input of the large language model 150.

In a process of training the large language model 150, the control unit 150 may train the large language model 150 based on or using an attention mechanism.

For instance, the attention mechanism may be a mechanism used in language modeling, which assigns weights to each element of a given input sequence (e.g., a text sequence tokenized through a tokenization process) and evaluates importance of each element according to the weights. The weights may be automatically adjusted while the model is trained, and determine how much each element contributes to the output. The attention mechanism may not process an entire input equally, and may focus on a part of the input most relevant at each point in time of output generation.

More specifically, the attention mechanism is configured to center on three elements of query, key, and value. The attention mechanism calculates similarity (or a score) between each query and each key, determines weights for each value based on the similarity, and then generates a final attention output by combining the values using the weights (e.g. summing the values). For example, a process of operating or calculating the attention may calculate an attention score or similarity score between each query and each key using an inner product (dot product) and/or cosine similarity, and convert the attention score or similarity score into a probability distribution by applying softmax to the calculated attention score or similarity score. Then, for the value vectors, the softmax result is multiplied by the weights, and these are summed to generate a final attention output.

That is, in the attention mechanism, each query token calculates relevance scores for all previous keys to generate a weighted sum of the values. In this case, an attention operation for an input of a sequence having a specific length may be represented as illustrated in (e) of FIG. 11. In (e) of FIG. 11, Attn is an attention function, and a definition of the attention function including attention weights between queries and keys and dimensions of key vectors may be represented as illustrated in (f) of FIG. 11.

The control unit 150 may train the large language model 150 for the training dataset 200 based on the preset attention mechanism. In the present disclosure, types of preset attention mechanisms that may be used (or utilized, etc.) in the training process of the large language model 150 may vary. For example, the preset attention mechanisms may include at least one of sparse attention, sliding-window attention, multi-head attention, self-attention, global attention, local attention, or cross-attention.

The large language model 150 may perform the training for the training dataset 200 based on the preset mechanism for long-context modeling.

Specifically, the large language model 150 may perform the training for the training dataset 200 based on a sparse attention mechanism in order to process long context.

The sparse attention mechanism may be a mechanism that, instead of calculating interactions among all elements within an input sequence (or input text sequence), performs attention only for partially selected token pairs according to a predetermined rule (e.g., a fixed manner) and/or a dynamic manner (e.g., a learning-based manner).

More specifically, the sparse attention may be a technique that does not perform operations for all or entire input token pairs, but selectively performs attention operations only for some important token pairs so as to minimize (or reduce) an amount of operations and memory usage. That is, the sparse attention may activate only a part (sparse portion) of an entire attention map so as to increase operation efficiency and optimize memory usage.

The control unit 150 may train the large language model 150 using the sparse attention mechanism so that the large language model 150 well processes long context included in the training dataset 200. When at least one text sequence included in the training dataset 200 is input to the large language model 150, the large language model 150 may selectively perform attention operations only for some query-key pairs selected according to a preset criterion (e.g., a preset selection criterion) among entire query-key pairs included in the input text sequence (or tokenized text). That is, the large language model 150 may perform attention operations by selectively connecting only a predetermined ratio of entire query-key pairs of the text sequence.

The preset criterion may include various criteria related to at least one of a predefined rule (or fixed manner) or a dynamic manner (or learning-based manner). For example, the preset criterion may include at least one of: (i) each token performs attention only with adjacent tokens (e.g., preceding or following 2 to 3 tokens); (ii) only tokens spaced at a predetermined interval are connected (e.g., always the 3rd token); (iii) tokens are divided into block units, and attention is performed only between specific blocks; (iv) full attention is assigned to special tokens (e.g., [CLS], the first token of a sentence, etc.); (v) each query token selects only k key tokens most similar thereto (k is a natural number); or (vi) similar tokens are clustered and attention is performed only within a cluster. However, the preset criterion is not necessarily limited only to the above-mentioned examples, and the criteria may be set in various ways.

As such, in an embodiment of the present disclosure, instead of each query operating with all keys, the attention is calculated only with some selected keys, thereby enabling the large language model 150 to efficiently process long sequences (long context), greatly reduce memory usage, and improve operation efficiency.

Meanwhile, in an embodiment of the present disclosure, in a process of processing a text sequence included in the training dataset 200 through the attention mechanism, the large language model 150 may be trained to process the text sequence using various manners or techniques.

When a text sequence is input to the large language model 150, the control unit 150 may train so that the tokens included in the input text sequence are processed in units of sliding-window (sliding-window attention), or are selectively processed in units of blocks (blockwise), or are processed based on importance.

Such processing manners, methods, or techniques, etc. may be understood to be used for a sparse operation (e.g., sparse computation) that considers only selected token pairs, not entire tokens. These processing manners may be used in various models aiming at improvement of operation efficiency, model compression, and sparse attention.

In one embodiment, the large language model 150 may process tokens included in an input text sequence in units of sliding windows. The large language model 150 may perform the training for the training dataset 200 based on the sliding-window attention.

The sliding-window attention mechanism may be a mechanism of dividing an input sequence into windows of a specific size (e.g., a preset size) and performing attention. In a general attention mechanism, since attention is calculated for all input elements, calculation cost increases as the input sequence becomes longer. In order to solve such a problem, according to an embodiment of the present disclosure, the sliding-window attention defines a window of a predetermined size in the input sequence when processing a long input sequence (or text sequence), and performs attention only for tokens included in the defined window.

More specifically, the sliding-window attention divides an input sequence into small windows and calculates attention for each divided window. A size of the window may be a fixed value or may be dynamically or variably adjusted by the system 100. The sliding windows perform attention only for a partial range of an input sequence or an input image, and instead of calculating attention for an entire input, apply attention only within a limited range. That is, the sliding-window attention may limit an attention operation of the large language model 150 to a restricted window around each token so as to efficiently process long sequences.

The control unit 150 may train the large language model 150 using the sliding-window attention mechanism so that the large language model 150 well processes long text sequences included in the training dataset 200. When at least one text sequence included in the training dataset 200 is input, the large language model 150 may set (or select) a sliding window of a preset size based on the input text sequence. In this case, the window is slid along the input sequence, and the large language model 150 may perform an attention operation for each window. That is, the large language model 150, instead of calculating attention for all input at once, may reduce an amount of operations by performing attention operations only within fixed windows. For example, in case where a length of the input text sequence is 100, when the size of the window is set to 10, each position performs attention only with 10 neighbors centered on itself.

As such, in an embodiment of the present disclosure, when processing a long sentence or text, by dividing an entire sequence into small pieces and processing the divided pieces instead of handling all at once, memory usage may be reduced and calculation cost may be optimized. In this way, in an embodiment of the present disclosure, when processing a long sentence or text, memory and calculation resources may be reduced or saved, thereby constructing a memory-efficient large language model 150.

In another embodiment, the large language model 150 may process tokens included in an input text sequence by selecting them in block units. An attention operation may be performed by selecting tokens of an input sequence in block units, where instead of calculating attention among all tokens, the input sequence is divided into a plurality of blocks, and only important tokens inside each block or between respective blocks are selected (or screened) to perform the attention operation.

When at least one text sequence included in the training dataset 200 is input, the large language model 150 may divide the input text sequence into a plurality of blocks having a specific size (e.g., a preset size), and may select only important tokens inside each block or between respective blocks, and perform an attention operation for the selected tokens. For example, in a case where a text sequence length is 1000 and the text sequence is divided into a plurality of blocks (e.g., 10 blocks) having a preset size, each of the plurality of blocks may include 100 tokens. The large language model 150 may evaluate importance for tokens included in each of the plurality of blocks, and based on the evaluated importance, may select at least one token having high importance among tokens included in each of the plurality of blocks, and may perform an attention operation (calculation) for the selected token. In this case, each of the plurality of blocks may also be processed independently, and selection of important tokens may be evaluated and selected based on at least one of an attention score, a degree of activation (activation magnitude), or a projection score.

That is, in an embodiment of the present disclosure, by dividing each sequence in block units and performing an attention operation only inside a block, efficiency of operation and memory may be improved.

In another embodiment, the large language model 150 may process tokens included in an input text sequence based on importance. When at least one text sequence included in the training dataset 200 is input, the large language model 150 may remove tokens having low utilization based on attention scores for the input text sequence, and may remove tokens judged to have low importance in a subsequent prediction process from the memory. In addition, the large language model 150 may identify important token features through attention weight analysis, and may selectively maintain only features of the identified important tokens, thereby improving efficiency of memory usage.

Meanwhile, the large language model 150 may be trained using at least one of a low-precision training technique or a mixed-precision training technique.

The term “low-precision training” refers to a training technique in which at least a portion of numerical representations used in training a large language model are represented with reduced numerical precision as compared to full-precision representations.

For example, while conventional training typically uses 32-bit floating-point representations, low-precision training may utilize 16-bit floating-point, 8-bit integer, or other reduced-precision numerical formats for model parameters, activations, gradients, or intermediate computation results.

The term “mixed precision training” refers to a training technique in which multiple numerical precision formats are selectively used during training of a large language model.

In mixed precision training, certain operations that are sensitive to numerical accuracy, such as parameter accumulation, loss computation, or gradient updates, may be performed using higher-precision numerical representations, while other operations, such as forward propagation or intermediate activation computations, may be performed using lower-precision numerical representations.

The large language model may be trained or fine-tuned using at least one of low-precision training or mixed precision training in combination with parameter-efficient adaptation techniques, such as Low-Rank Adaptation (LoRA).

For example, during an unlearning process, parameters of a pre-trained large language model may be fixed, while only low-rank adapter parameters are updated. In such cases, low-precision or mixed precision training may be applied to the adapter parameters to reduce computational overhead and accelerate the unlearning process.

The low-precision training may include an operation of performing the training for the large language model 150 using a low-precision numerical representation (or format) in a process of training the large language model 150. More specifically, the low-precision training comprise be a method of performing parameters and operations of the large language model 150 with low-precision numerical representation, where generally deep learning uses 32-bit floating point (float32), but low-precision training trains a model using 16-bit (float16), 8-bit (int8), or fewer bits. In an embodiment of the present disclosure, through the low-precision training for the large language model 150, the training of the large language model 150 and calculation efficiency may be improved, and memory and operation resources may be reduced or saved. In this case, the low-precision training may allow the large language model 150 to perform the training with less memory and faster speed while maintaining high performance.

Mixed-precision training may include an operation of performing training of the large language model 150 by mixing various numerical precisions. More specifically, the mixed-precision training may comprise an operation of training a model by mixing two data types (e.g., 32-bit and 16-bit), where important calculations (e.g., weight update, model parameter update, loss calculation, etc.) are performed with high precision (32-bit), and other calculations (e.g., activation function, intermediate calculation, etc.) may be performed with low precision (16-bit). That is, the mixed-precision training may significantly improve training speed and memory efficiency while maintaining the accuracy of the model. As such, in an embodiment of the present disclosure, through the mixed-precision training for the large language model 150, the efficiency of GPUs may be increased or maximized, memory usage may be reduced, and training speed may be improved or increased.

Meanwhile, the large language model 150 trained through the above-described operations may correspond to a teacher model configured to distill knowledge learned (or acquired) through the training for the training dataset 200 into at least one model corresponding to a student model.

Model distillation may also be referred to as knowledge distillation, and may include an operation of transferring knowledge learned from a large model (e.g., a teacher model) to a small model (e.g., a student model), thereby improving calculation efficiency while maintaining performance.

That is, in an embodiment of the present disclosure, without retraining a small model through separate training data, reasoning ability of a large model may be imparted to a small model through model distillation. Through this, an embodiment of the present disclosure may be usefully utilized even in resource-limited environments and may significantly reduce operation cost in a model training process. In addition, a small model may maintain performance obtainable from a large model by efficiently compressing and learning knowledge of the large model.

Further, the control unit 150 may acquire the large language model 150 trained through the above-described process.

However, the large language model utilized in the unlearning process described below is not limited only to the models trained through the above-described process. For example, the large language model may include a model pre-trained through supervised learning using labeled training data. Alternatively, the large language model may include a model trained through reinforcement learning.

Meanwhile, in an embodiment of the present disclosure, in a training dataset stored in the memory, a process of specifying forgetting data and retaining data for the pre-trained large language model (LLM) may be performed.

The control unit 140 may specify forgetting data (e.g., “forget set”), which corresponds to data of which a learned result is to be removed, among data trained previously (or in advance) for the large language model 150, and retaining data (e.g., “retain set”), which corresponds to data of which a learned result is to be retained.

As illustrated in FIG. 4, the control unit 140 may specify training data to be unlearned so as to be unrecognizable through the large language model 150 in a training dataset 200 used in a training process of the large language model 150, as forgetting data 210, and may specify training data to be retained in a recognizable state through the large language model 150 as retaining data 220.

For example, the control unit 140 may specify, as the forgetting data 210, a text sample (or text data, text sequence, token sequence, language data, etc.), which is a target to be removed (i.e., target for removal), in the training dataset 200 used in training of the large language model 150, so as to be unrecognizable through the large language model 150.

In another example, the control unit 140 may specify, as the retaining data 220, a text sample to be retained in a recognizable state through the large language model 150 in the training dataset 200 used in training of the large language model 150.

In the present disclosure, various manners for specifying forgetting data and retaining data may be implemented. In an embodiment of the present disclosure, specification of forgetting data and retaining data may be achieved based on user input (or request), or may be achieved by the unlearning system 100 itself.

In one embodiment, after the pre-training of the large language model 150 is completed, when a user requests deletion of specific data from the training dataset 200 used in the training of the large language model 150, the control unit 140 may specify the specific data requested by the user (e.g., data received from the user terminal 10) as forgetting data 210, and may specify remaining data other than the specified forgetting data 210 as the retaining data 220.

In another embodiment, the unlearning system 100 may analyze the training dataset 200 used in the training process of the large language model 150 based on preset criteria (or conditions). For instance, the preset criteria may be criteria set in relation to user's personal information (e.g., name, address, phone number, email, etc.) or copyright infringement factors. As a result of the analysis, when data related to the preset criteria is detected (or filtered) in the training dataset 200 used in training of the large language model 150, the unlearning system 100 may specify the detected data as the forgetting data 210, and may specify remaining data other than the specified forgetting data 210 as the retaining data 220.

In yet another embodiment, when the unlearning system 100 performs fine-tuning so that only recognition for text data corresponding to a specific item (or type) is possible for the large language model 150 trained based on large-scale text data, the training data related to data corresponding to the specific item may be specified as the retaining data 220, and the training data related to data corresponding to an item other than the specific item may be specified as the forgetting data 210.

In this case, the unlearning system 100 may be understood as performing unlearning for data corresponding to the other item, and here, the specific item or the other item may be understood to refer to a category (or type) for data recognizable through the large language model 150.

In addition, the retaining data 220 may include not only previously learned data for the large language model 150, but also training data related to an item to be newly trained.

However, in the present disclosure, a manner (or method) of specifying the forgetting data 210 and the retaining data 220 is not necessarily limited to the embodiments described herein, and the forgetting data 210 and the retaining data 220 may be specified according to various manners.

In an embodiment of the present disclosure, the training dataset 200 may be represented as illustrated in (a) of FIG. 7, the forgetting data 210 may be represented as illustrated in (b) of FIG. 7, and the retaining data 220 may be represented as illustrated in (c) of FIG. 7.

Meanwhile, in an embodiment of the present disclosure, by comparing forgetting data and retaining data, an operation of specifying a specific parameter having high importance for the forgetting data among parameters of a large language model may be performed.

Here, the operation of comparing the forgetting data and the retaining data may comprise comparing and analyzing relative importance of parameters for the forgetting data 210 and the retaining data 220.

A parameter may mean a learnable value including weights and biases of a model. The parameters may be adjustable values used when the model learns and predicts (or performs reasoning) data. For example, in an artificial neural network, weights of each layer may be regarded as parameters. Such parameters are optimized through a training process, and through this, the model may learn patterns from data and perform prediction.

The change of parameters (or variables, weights, etc.) due to adaptation of the large language model 150 may essentially have a low-rank (or low-dimensional, low-order, etc.) structure. More specifically, based on an assumption that the change of parameters of the large language model 150 due to adaptation of the large language model 150 has a low-rank, the change may be approximated by low-rank matrices.

Here, the adaptation of the large language model may be a process of altering or adjusting a previously trained model to suit a specific purpose (or task), and may include, for example, training, fine-tuning, unlearning, and the like.

In addition, that the parameter change of the large language model 150 has a low-rank (or low-rank structure) may mean that when parameters (e.g., weight matrices) of the large language model 150 change, the change occurs in a relatively lower-dimensional subspace in the entire parameter space. This may mean that not all weights are altered independently, but the change is made according to a specific low-rank structure. That is, major changes occur not in the entire weight matrix of the large language model 150, but in a specific low-rank (e.g., having a small rank) part. For example, when the model learns data of a specific domain, this may be understood as meaning that not all neurons are equally updated, but only some neurons play a major role.

As described above, assuming that the parameter change due to adaptation of the large language model 150 is low-rank, Low-Rank Adaptation (LoRA) models parameter change of each linear weight (e.g., linear layer weight (or weight matrix) of the large language model 150) as a product of two low-rank matrices. Here, each linear weight may be represented as illustrated in (d) of FIG. 7, and the parameter change may be represented as illustrated in (e) of FIG. 7. In addition, two low-rank matrices A and B may be represented as illustrated in (f) of FIG. 7, and a rank of the LoRA adapter may be represented as illustrated in (g) of FIG. 7. When an input is given to the large language model 150, an output of an adapted linear layer may be represented as illustrated in (h) of FIG. 7.

During the fine-tuning of the large language model 150, existing weights of the pre-trained large language model 150 are fixed, and only the low-rank matrices A and B may be updated through gradient descent. To ensure that the initial attachment of the LoRA adapter does not alter the output of the large language model 150, LoRA defaults to initializing a first low-rank matrix A with a Kaiming-uniform distribution and setting a second low-rank matrix B to a zero matrix. Then, after fine-tuning of the large language model 150 is completed, the LoRA adapter may be merged with existing weights (see (i) of FIG. 7).

The LoRA may be a manner (or technique, method, etc.) of modeling weight matrix change as a product of two low-rank matrices, and updating a model through low-rank change instead of adjusting entire weights. In an embodiment of the present disclosure, without retraining the large language model 150, unlearning for the large language model 150 may be performed in a direction of reducing an amount of operations and increasing efficiency, based on an assumption that parameter change of the large language model 150 mainly occurs in a low-rank region.

In an embodiment of the present disclosure, for each parameter (or weight) of the large language model 150, Fisher information may be measured, and based on the measured result, a weight low-rank decomposition for initializing adapter weights A and B may be performed. In the present disclosure, such a process may also be referred to as “FLoRA (Fisher-weighted LoRA Initialization)”.

In the FLoRA process according to an embodiment of the present disclosure, it is set so that more important parameters for the forgetting data 210 are preferentially adjusted, thereby allowing the large language model 150 to quickly unlearn the forgetting data 210 and aiming to minimize performance degradation for the retaining data 220. To this end, in an embodiment of the present disclosure, parameter importance for each of the forgetting data 210 and the retaining data 220 may be quantified using a Fisher information matrix, and initialization of the large language model 150 may be performed based on this.

The control unit 140 may measure parameter importance for each of the forgetting data 210 and the retaining data 220 using the Fisher information matrix. The control unit 140 may measure how important each weight (or specific weight) of the large language model 150 is for each of the forgetting data 210 and the retaining data 220 using a Fisher information matrix.

Here, the Fisher information matrix may indicate an amount of information that the training dataset 200 provides to parameters of the large language model 150. The Fisher information matrix may be represented as illustrated in (a) of FIG. 8.

The Fisher information matrix may be calculated as a second central moment of a first partial derivative of a log-likelihood (see left side of (c) of FIG. 8). However, since integrating over a space of the training dataset 200 is computationally impossible, in an embodiment of the present disclosure, empirical Fisher information (or an empirical Fisher information matrix) may be utilized. The empirical Fisher information may be represented as illustrated in (b) of FIG. 8. In case of the large language model, the empirical Fisher information may be calculated as a mean of squares of gradients propagated in a language modeling objective (e.g., cross-entropy loss) (see (c) of FIG. 8). However, in the present disclosure, the terms “Fisher information matrix (or Fisher information)” and “empirical Fisher information matrix (or empirical Fisher information)” may be used interchangeably.

The Fisher information matrix may mean a value indicating how important a specific parameter of the model is in given data. More specifically, the Fisher information matrix may mean a measure (or value) indicating whether at least one parameter (or target parameter, specific parameter, etc.) of the large language model is important for a text sample (e.g., sentence, document, token sequence, paragraph, etc.) included in the forgetting data 210 or the retaining data 220. For example, the Fisher information matrix may serve as a measure indicating whether a specific parameter of the large language model 150 is important for specific data, and the measure representing the importance may be expressed as a gradient.

In this case, a parameter having a large absolute value of a gradient may be specified (or determined, judged, regarded, etc.) as important in the corresponding data. That is, a parameter having a large gradient for specific data may be specified as playing an important role in generating the corresponding data.

Therefore, a parameter having a high absolute value of a gradient for the forgetting data 210 may be specified as having relatively high importance in the forgetting data 210, and a parameter having a high absolute value of a gradient for the retaining data 220 may be specified as having relatively high importance in the retaining data 220.

The control unit 140 may measure a Fisher information matrix for each of the forgetting data 210 and the retaining data 220.

Specifically, the control unit 140 may compute, for each parameter of the large language model 150, a Fisher information matrix for the forgetting data 210 and another Fisher information matrix for the retaining data 220 using the forgetting data 210 and the retaining data 220. The control unit 140 may acquire the Fisher information matrix for the forgetting data 210 measured or calculated using the forgetting data 210 for each parameter of the large language model 150, and the Fisher information matrix for the retaining data 220 measured or calculated using the retaining data 220. Here, the Fisher information matrix measured for the forgetting data 210 may be represented as illustrated in (d) of FIG. 8, and the Fisher information matrix measured for the retaining data 220 may be represented as illustrated in (e) of FIG. 8.

In another embodiment, the control unit 140 may set (or select) at least one target parameter (target) among parameters of the large language model, and may measure or calculate a Fisher information matrix for the forgetting data 210 and a Fisher information matrix for the retaining data 220 for the target parameter using the forgetting data 210 and the retaining data 220. The control unit 140 may acquire the Fisher information matrix for the forgetting data 210 measured or calculated using the forgetting data 210, and the Fisher information matrix for the retaining data 220 measured or calculated using the retaining data 220, for the target parameter. In this case, the target parameter may be set (or selected) randomly, or may be set based on preset criteria (e.g., which may vary, such as a parameter having a high training weight, a parameter having a high generation probability distribution of the forgetting data, etc.).

At step S401 of FIG. 4, the control unit 140 may measure (or analyze, quantify) parameter importance for each of the forgetting data 210 and the retaining data 220 using the Fisher information matrix for the forgetting data 210 and the Fisher information matrix for the retaining data 220.

Here, the parameter importance may be measured or calculated using a relative Fisher information matrix between the Fisher information matrix for the forgetting data 210 and the Fisher information matrix for the retaining data 220. The control unit 140 may preferentially specify (or select, identify, etc.) parameters that have high importance in the forgetting data 210, but low importance in the retaining data 220, using the relative Fisher information matrix between the forgetting data 210 and the retaining data 220 as an importance index. The relative Fisher information matrix may be represented as illustrated in (f) of FIG. 8.

The relative Fisher information matrix may be calculated using the Fisher information matrix for the forgetting data 210 and the Fisher information matrix for the retaining data 220. In this case, calculating the relative Fisher information matrix may also be understood as calculating relative importance of parameters for the forgetting data 210 and the retaining data 220.

The control unit 140 may calculate a relative Fisher information matrix between the Fisher information matrix measured or calculated for each of the forgetting data 210 and the retaining data 220, and may measure (or analyze, quantify) parameter importance for each parameter of the large language model 150 based on the calculated result.

As a result of measurement or calculation of parameter importance, the control unit 140 may specify (or determine, select, etc.) at least one parameter, having a high Fisher information matrix measured for the forgetting data 210, among parameters of the large language model 150, as a specific parameter. At step S402 of FIG. 4, the control unit 140 may specify a parameter having high parameter importance for the forgetting data 210 as a specific parameter. The specific parameter may be understood as a parameter having a large absolute value of a gradient for the forgetting data 210, and having relatively high importance in the forgetting data 210.

That is, in an unlearning process according to the present disclosure, high Fisher information for the forgetting data 210 may indicate that a next-token prediction loss in the forgetting data 210 induces a large absolute gradient at the corresponding parameter. Therefore, in an embodiment of the present disclosure, the parameter may be specified as a specific parameter important for generating a sequence of the forgetting data 210. In the present specification, the specific parameter may also be referred to as a “specific weight”, an “important parameter”, or an “important weight”.

In another embodiment, the control unit 140 may calculate a relative Fisher information matrix between the Fisher information matrix for the forgetting data 210 and the Fisher information matrix for the retaining data 220, which are calculated or measured for a target parameter, and may measure (or analyze), based on the calculated result, for which data the target parameter has higher importance. As a result of the calculation or measurement of importance of the target parameter, the control unit 140 may specify the target parameter as a specific parameter when the target parameter has high importance for the forgetting data 210. In contrast, as a result of the calculation of measurement of importance of the target parameter, the control unit 140 may exclude the target parameter from initialization target when the target parameter has high importance for the retaining data 220, and may re-perform the above-described process for specifying a parameter having high importance for the forgetting data 210.

Accordingly, the control unit 140 may identify or specify, as a specific parameter, a parameter among parameters of the large language model 150, having relatively high Fisher information for the forgetting data 210 compared to the Fisher information for the retaining data 220. For example, the control unit 140 may preferentially identify or specify a specific parameter having high Fisher information for the forgetting data 210 but low Fisher information for the retaining data 220.

That is, the control unit 140 may compare the forgetting data (e.g., Fisher information for the forgetting data) and the retaining data (e.g., Fisher information for the retaining data), and identify or specify, as a specific parameter to be set to be preferentially adjusted in the unlearning process, a parameter having high (or important) importance for the forgetting data 210 and low (or unimportant) importance for the retaining data 220.

In an embodiment of the present disclosure, based on the specific parameter having high importance for the forgetting data, an operation of initializing a weight of Low-Rank Adaptation (LoRA) may be performed.

The control unit 140 may initialize a weight of a preset adapter based on an importance of a specific parameter.

Here, the importance of the specific parameter may be a value or an index numerically representing a contribution of the corresponding parameter when the large language model 150 predicts tokens included in the forgetting data 210. For instance, the importance of the specific parameter may be a value indicating how greatly a specific parameter affects the forgetting data 210, and may be quantified by the Fisher information and/or the relative Fisher information described above.

In addition, the preset adapter may be related to the LoRA adapter described above. For example, the control unit 140 may model the preset adapter configured to approximate a parameter change of the large language model 150 through a plurality of low-rank matrix multiplications, based on the specific parameter having a high importance for the forgetting data 210, and may initialize a weight of the adapter.

In an embodiment of the present disclosure, the initialization operation may be an operation of calculating relative importance of parameters for the forgetting data 210 and the retaining data 220, and performing LoRA initialization based on a calculated result. In addition, the initialization operation may be a process of initializing weights A and B of LoRA so that parameters important for the forgetting data 210 become larger.

In addition, the initialization operation may be an operation of initializing weights A and B of a LoRA adapter based on a specific parameter having high importance for the forgetting data 210, so that the unlearning process is performed centered on the specified parameter, thereby allowing the corresponding weights to focus on removal of knowledge of the forgetting data 210.

In addition, the initialization operation may be an operation of applying the LoRA to the specific parameter having high importance for the forgetting data 210 (e.g., decomposing the specific parameter into adapter weights A and B of the LoRA), and initializing the weights A and B of the LoRA by reflecting information (e.g., Fisher information, relative Fisher information, etc.) for the specific parameter. For example, existing weights W of the pre-trained large language model 150 are fixed so that an output of the model is not changed when the LoRA is applied.

In addition, the initialization operation may be an operation of initializing a weight of the LoRA (or a weight of an LoRA adapter) based on importance (e.g., importance information) of the specific parameter having high importance for the forgetting data 210, so that knowledge for the forgetting data 210 is effectively removed.

In addition, the initialization operation may be an operation of initializing weights (e.g., low-rank matrices) of the LoRA so that importance of the specific parameter having high importance for the forgetting data 210 is reflected. In addition, the initialization operation may comprise an operation of initializing a weight of LoRA based on relative importance of the specific parameter having high importance for the forgetting data 210, thereby inducing unlearning to be quickly and efficiently performed centered on the specified parameter through adjustment for the corresponding parameter.

In addition, the initialization operation may be an operation of initializing low-rank matrices A and B of the LoRA adapter (i.e., LoRA) in a direction reflecting importance of the specific parameter having high importance for the forgetting data 210, so that unlearning is effectively performed (In an embodiment, weights of the pre-trained large language model may be fixed).

The initialization process may select (or specify) important information only for the forgetting data 210 among the forgetting data 210 and the retaining data 220, and may reflect it in the initialization of the LoRA. At step S403 of FIG. 4, the control unit 140 may initialize a weight of the LoRA so that the unlearning of the large language model can be performed centered on a specific parameter having a high importance for the forgetting data 210.

In one embodiment, when the weight of the LoRA is initialized with parameters important for generating the forgetting data 210, only parameters important for the forgetting data 210 are modified by a gradient, and remaining parameters are retained, which may be advantageous in the unlearning process. When relative importance for each parameter of the large language model 150 is given, a solution of a weighted low-rank approximation (WLRA) problem may be represented as initialization of a weight of the LoRA adapter. This may be represented as illustrated in (a) of FIG. 9.

In this case, in the present disclosure, it may be assumed that parameters of each row of the large language model 150 have the same importance, and a weighted low-rank approximation problem may be redefined using a square root of a row-wise sum of a relative Fisher information matrix. This may be represented as illustrated in (b) of FIG. 9.

Here, a vector in which all elements are 1 may be represented as illustrated in (c) of FIG. 9, and a function for converting the vector into a diagonal matrix and a product of matrix-vector may be represented as illustrated in (d) of FIG. 9. As such, a row-wise weighted low-rank approximation (or Fisher information-based weighted low-dimensional approximation) problem may have a closed-form solution, and as illustrated in (e) of FIG. 9, the solution may be calculated by applying a singular value decomposition (SVD) of rank (r). In this case, an optimal low-rank matrices A and B in an embodiment of the present disclosure may be calculated as illustrated in (f) of FIG. 9.

Here, the solution may include an optimal weight of LoRA acquired by low-rank approximating existing model weights W including important information in the forgetting data 210. For example, the solution may be a low-rank approximation solution of a weight matrix having high importance for the forgetting data 210 but low importance for the retaining data 220.

After calculating the solution, the control unit 140 may use the calculated optimal low-dimensional matrix as an initial weight of LoRA (see (g) of FIG. 9). After the LoRA initialization, the control unit 140 may update a layer of the large language model 150 so that an output of the large language model 150 cannot be distorted. That is, the unlearning system 100 may extract a specific parameter important for the forgetting data 210 but not important for the retaining data 220, so that the LoRA tuning can be focused on removing knowledge for the forgetting data 210.

As such, in the initialization operation according to an embodiment of the present disclosure, among the forgetting data 210 and the retaining data 220, important information for the forgetting data 210 may be specified and reflected in the initialization process. As described above, in an embodiment of the present disclosure, a Fisher information-based weighted low-rank approximation may be performed so that only specific parameters important for the forgetting data 210 are reflected in low-rank matrices of the LoRA. The control unit 140 may apply Fisher information-based weighted low-rank approximation, and initialize matrices A and B of the LoRA by selecting parameters including relatively important information in the forgetting data 210, thereby allowing fast and precise learning of information to be deleted.

In an embodiment of the present disclosure, an operation of performing unlearning for the trained large language model to which a weight of the LoRA is applied may be performed.

The control unit 150 may perform the unlearning for the trained large language model 150 based on the result of performing the initialization of the weight of LoRA. That is, after the initialization operation is completed, the unlearning may be performed in the large language model 150 to which the initialized weight of LoRA is applied (or a weight of LoRA adapter is applied).

In this case, while the unlearning is performed in the large language model 150, parameters of the pre-trained large language model 150 are fixed, and only a weight of the LoRA may be updated. In this case, in the process of performing unlearning for the forgetting data 210, a set of retaining data 220 including general knowledge may be used together.

The control unit 140 may perform the unlearning for the large language model 150 using a preset loss function so as to effectively remove data (i.e., forgetting data) to be removed, and increase efficiency for data (i.e., retaining data) to be retained. For example, in an embodiment of the present disclosure, the preset loss function for the unlearning of the large language model 150 may be a final loss function using Inverted Hinge Loss (IHL). Such a loss function may be represented as illustrated in (h) of FIG. 9.

The unlearning of the large language model 150 may be performed in a direction of minimizing the final loss function through probabilistic gradient descent with backpropagation by sampling text corpora (or data) from each dataset.

Specifically, as illustrated in FIG. 6, at S404 of FIG. 4, the large language model 150 may perform the unlearning for the forgetting data 210 using the preset loss function. In this case, while increasing a prediction probability for the retaining data 220 of the large language model 150, the control unit 140 may perform the unlearning for the large language model using the loss function so that a prediction probability for the forgetting data 210 can be decreased. That is, the control unit 140 may perform the unlearning for the large language model 150 using the loss function so that knowledge for data to be retained (i.e., retaining data) can be retained, while data to be removed (i.e., forgetting data) can be efficiently removed, without affecting reasoning ability and generation ability of the large language model 150.

As described above, in an embodiment of the present disclosure, while reducing a prediction score for an actual token (or true token), only prediction scores for a small number of other tokens are increased, thereby performing unlearning effectively. To this end, the Inverted Hinge Loss used in the preset loss function in the present disclosure may be represented as illustrated in (a) of FIG. 10.

First, the control unit 140 may perform the unlearning for the large language model 150 using the loss function in a direction of decreasing a prediction probability (or prediction score) for the forgetting data 210, so that the large language model 150 removes (or does not generate, recognize, perform reasoning, etc.) knowledge for the forgetting data 210.

More specifically, the control unit 140 may adjust a probability distribution of the large language model 150 in a direction of decreasing a prediction probability for the true token included in the forgetting data 210, so that a prediction probability for the forgetting data 210 of the large language model 150 is decreased (see FIG. 6). A probability of the true token may be represented as illustrated in (b) of FIG. 10.

In addition, the control unit 140 may maximize a log probability for the retaining data 220 using the loss function so that the large language model 150 retains knowledge for the retaining data 220 (or retains ability to generate (or recognize, perform reasoning, etc.) the retaining data 220). For example, the control unit 140, in order to retain (or increase) ability of the large language model 150 to generate the retaining data 220, may maximize a log probability for the retaining data 220, and adjust balance so that the model cannot perform forgetting more than necessary.

More specifically, the control unit 140 may adjust a probability distribution of the large language model 150 in a direction of increasing a prediction probability for an alternative token having the highest probability among all tokens except the true token, so that the large language model 150 retains ability to generate the retaining data 220 (see FIG. 6). Here, the alternative token may correspond to one token having the highest probability of replacing the true token among all tokens excluding the true token. Such an alternative token may be represented as illustrated in (c) of FIG. 10.

In addition, all tokens may be remaining tokens excluding the true token among tokens included in a vocabulary set of the pre-trained large language model 150, and for example, the vocabulary set may mean a set of words or sub-word units that the model may use. In another example, all tokens may include at least one among tokens included in the retaining data 220 set.

Such a minimum probability difference between the true token and the alternative token may be represented as illustrated in (d) of FIG. 10, and ensuring that a loss value is limited to be not less than 0 may be represented as illustrated in (e) of FIG. 10. The Inverted Hinge Loss (see (a) of FIG. 10) used in the preset loss function according to an embodiment of the present disclosure may converge the loss to 0 when a probability of the true token becomes sufficiently smaller than that of the alternative token having the highest replaceability (e.g., when the unlearning is completed). In this case, a case where the unlearning is completed may be represented as illustrated in (f) of FIG. 10, and a case where unlearning is not yet completed may be represented as illustrated in (g) of FIG. 10.

In one embodiment, considering a probability of the true token defined through a softmax function, a derivative of the Inverted Hinge Loss with respect to a logit value of a specific word v at a point in time t of the large language model (see (a) of FIG. 11) may be represented as illustrated in (b) of FIG. 11.

In addition, in a gradient calculation operation of the Inverted Hinge Loss, when unlearning is in progress (see (c) of FIG. 11), a probability of the true token may be decreased and a probability of the alternative token may be increased. In this case, since an absolute value of the gradient is greater than or equal to that of the alternative token, a probability of the true token may decrease more rapidly. Although adjustment is made in a direction of increasing the probability of the alternative token, the probability of the alternative token may be increased more slowly than the probability of the true token (since the absolute value of the gradient of the alternative token is smaller than that of the true token). Further, other tokens may be slowly increased in probability in proportion to a probability difference between the true token and the alternative token.

Furthermore, in a gradient calculation operation of the Inverted Hinge Loss, in a case where the unlearning is completed (see (d) of FIG. 11), when a value of “a difference between a probability of the true token and a probability of the alternative token +1” is smaller than 0, the loss may converge to 0.

That is, in an embodiment of the present disclosure, while decreasing a probability of the true token and increasing a probability of the alternative token, when the unlearning of the large language model 150 for the forgetting data 210 is completed, the loss may converge to 0 to stably terminate the unlearning process. Through this, gradient updates may be efficiently performed without affecting reasoning ability and generation ability of the large language model 150.

Meanwhile, as described above, an embodiment of the present disclosure may be applied to various industries and services to be usefully utilized. An embodiment of the present disclosure may be applied to and usefully utilized in at least one among opt-out applications, natural language generation-related services, conversational AI and chatbots, text generation AI and content generation, personalized education and language learning, social media and online platforms, harmful content filtering, medical and healthcare, finance and law, and games and virtual environments.

Referring to FIG. 12, a method and system for large language model unlearning according to an embodiment of the present disclosure may include: a step S1210 of receiving a user input requesting deletion of specific data among a training dataset used in training of the large language model (LLM) at an inference stage; a step S1220 of specifying data corresponding to the specific data in the training dataset as forgetting data based on the received user input, and specifying remaining data excluding the forgetting data as retaining data; a step S1230 of specifying a specific parameter having high importance for the forgetting data among parameters of the large language model by comparing the forgetting data and the retaining data; a step S1240 of initializing weights of Low-Rank Adaptation (LoRA) based on the specific parameter having high importance for the forgetting data; and a step S1250 of performing unlearning for the large language model to which the weights of the LoRA are applied.

As illustrated in FIG. 13, the control unit 140 may receive a user input (e.g., “delete the data I request . . . ”) requesting deletion of specific data 1400 in the training dataset 200 used in the training of the large language model 150, from the user terminal 10. The user input may be received through various manners. For example, the user input may be received through various manners such as selection of specific data by a user through a user interface, text query input of the user for specific data to be deleted, voice input of the user for specific data to be deleted, or the like, and is not necessarily limited to the above-described cases.

The control unit 140 may analyze specific data corresponding to a received user input, and based on the analyzed result, may specify data corresponding to specific data 1400 among the training dataset 200 used in training of the large language model 150 as the forgetting data 210. In addition, the control unit 140 may specify remaining data excluding the forgetting data 210 as the retaining data 220.

When the forgetting data 210 and the retaining data 220 are specified, the control unit 140, for each parameter of the large language model 150, may calculate or measure a Fisher information matrix for the forgetting data 210 and a Fisher information matrix for the retaining data 220 using the forgetting data 210 and the retaining data 220. Based on the calculate or measured result, the control unit 140 may acquire the Fisher information matrix for the forgetting data 210 measured using the forgetting data 210, and the Fisher information matrix for the retaining data 220 measured using the retaining data 220. Furthermore, the control unit 140 may measure (or analyze, quantify) parameter importance using the acquired Fisher information matrix for the forgetting data 210 and the Fisher information matrix for the retaining data 220. As a result of measurement of parameter importance, the control unit 140 may specify, as a specific parameter, a parameter having high parameter importance for the forgetting data while having low importance for the retaining data 220.

Finally, the control unit 140 may initialize a weight of Low-Rank Adaptation (LoRA) based on the specific parameter having high importance for the forgetting data. The control unit 150 may perform the unlearning for the large language model 150 to which a weight of LoRA is applied. More specifically, the control unit 140 may perform the unlearning for the large language model using the loss function so that a prediction probability for the forgetting data 210 is decreased, while increasing a prediction probability for the retaining data 220 of the large language model 150. Decreasing a prediction probability of the large language model 150 for the true token included in the forgetting data, and increasing a prediction probability of the large language model 150 for an alternative token having the highest probability among all tokens excluding the true token may decrease a prediction probability for the forgetting data 210 is decreased.

Furthermore, when the unlearning for the forgetting data 210 is completed, whether forgetting of the forgetting data 210 of the large language model 150 is performed may be determined (or judged). The determination of whether forgetting is performed may be determined according to various criteria. For example, whether the forgetting of the forgetting data 210 is performed may be autonomously determined based on preset criteria (e.g., user history information, user personal information (e.g., name, address, phone number, email, etc.), criteria set in relation to copyright infringement elements, etc.) by an administrator or a user of the unlearning system 100 or an artificial intelligence model 160.

In one embodiment, in order to identify whether the forgetting of the forgetting data 210 is performed, a query related to the forgetting data 210 may be input to the large language model 150. When the unlearning for knowledge of the forgetting data 210 is completed, the large language model 150 may provide an answer to a user indicating that the unlearning for the forgetting data 210 is completed.

As such, the unlearning system 100 may delete knowledge for specific data 1400 requested to be deleted by the user, and may retain knowledge for data to be retained. That is, the unlearning system 100 may delete knowledge for the specific data 1400 corresponding to a deletion request of the user from a training result of the large language model 150, and may efficiently retain knowledge for the retaining data 220 to be retained in the training result.

As described above, according to some embodiments of the present disclosure, a method and system for optimizing a large language model, and a method for controlling a large language model optimization system may train the large language model with respect to a training dataset based on a preset attention mechanism. Through this, certain embodiments of the present disclosure may enable the large language model to efficiently process long sentences or texts, reduce a memory usage, and improve operation efficiency.

In addition, according to certain embodiments of the present disclosure, a method and system for optimizing a large language model, and a method for controlling a large language model optimization system may train the large language model in a direction to process text sequences using various manners or techniques. Through this, when processing a long sentence or text, some embodiments of the present disclosure may reduce or save memory and calculation resources, thereby constructing a memory-efficient large language model. The constructed large language model may provide a high reasoning ability and performance in various reasoning tasks (e.g., coding, mathematics, science, logical reasoning, etc.).

In addition, as described above, according to some embodiments of the present disclosure, a method and system for unlearning of a large language model and a method for controlling an unlearning system of a large language model may calculate or measure Fisher information for each of forgetting data and retaining data, and perform the unlearning on the large language model based on the calculated or measured result. Accordingly, in certain embodiments of the present disclosure, by selecting and preferentially adjusting only relatively important parameters (or weights) for forgetting data (e.g., data to be forgotten), knowledge regarding retaining data (e.g., data to be retained) may be retained, while knowledge regarding the forgetting data may be effectively removed. Through this, some embodiments of the present disclosure may reduce or minimize influence on the retaining data, while more quickly unlearning the forgetting data, thereby maintaining or improving an existing performance of the model.

Further, according to certain embodiments of the present disclosure, a method and system for unlearning of a large language model and a method for controlling an unlearning system of a large language model may analyze relative importance for the forgetting data and the retaining data, and perform an initialization operation of selectively adjusting only important parameters for the forgetting data based on the analyzed result. Through this, some embodiments of the present disclosure may reduce unnecessary operation in an unlearning process, and save calculation cost, and efficiently perform the unlearning operation in terms of time and resources without re-training an entire model.

Further, according to some embodiments of the present disclosure, a method and system for unlearning of a large language model and a method for controlling an unlearning system of a large language model may concentrating gradient update only on a minimum number of alternative tokens (viable replacements) having a high replaceability of a true token, data to be removed may be effectively removed, while language generation ability and reasoning performance of the existing model may be maintained. Through this, certain embodiments of the present disclosure may prevent or reduce performance degradation that may occur in a process of information deletion of the model, and provide an environment capable of solving privacy protection and copyright problems. That is, some embodiments of the present disclosure may prevent unnecessary loss diffusion and perform effective unlearning and maintain or improve natural sentence generation ability of the model by adjusting only a minimum number of alternative tokens having a high replaceability, even in a situation where unlearning for specific data is to be achieved.

According to certain embodiments of the present disclosure, by preferentially adjusting important parameters in the forgetting data and minimizing information loss of the retaining data, only specific data may be removed without retraining the entire model, so that operation cost and operational (maintenance or management) cost may be greatly reduced. In some embodiments of the present disclosure, data that a user wants to delete may be quickly unlearned, thereby complying with data protection laws, reducing enterprise operational cost, improving reliability of an AI system, and the like, and therefore the present disclosure may be usefully utilized in various industries or services.

Meanwhile, some embodiments of the present disclosure described above may be implemented based on a quantum computer. Certain embodiments of the present disclosure implemented based on the quantum computer may include a quantum processor and quantum memory based on qubits, and may include a software and hardware interface optimized for quantum operations.

The quantum processor of the quantum computer may efficiently process complex operations through parallel operation, quantum entanglement, quantum superposition, etc. using qubits, which cannot be performed by binary bits in the classical computer. The quantum processor may process data using a quantum gate and may provide exponential speed improvements for specific problems.

Meanwhile, certain embodiments of the present disclosure described above may be executed by one or more processes on a computer and implemented as a program that may be stored on a computer-readable medium (or recording medium).

Further, some embodiments of the present disclosure described above may be implemented as computer-readable code or instructions on a medium in which a program is recorded. That is, certain embodiments of the present disclosure may be provided in the form of a program.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, optical data storage devices, and the like.

Further, the computer-readable medium may be a server or cloud storage that includes storage and that the electronic device is accessible through communication. In this case, the computer may download the program according to the present disclosure from the server or cloud storage, through wired or wireless communication.

A computer program may reach the system 100 through various suitable delivery mechanisms. The delivery mechanism may be, for example, a computer-readable storage medium, a computer program product, a memory device, a recording medium such as a CD-ROM or DVD, or a product that tangibly implements a computer program. The delivery mechanism may be a signal configured to reliably transmit a computer program through air or an electrical connection. The system 100 may propagate or transmit the computer program as a computer data signal.

Further, references to “computer-readable storage medium”, “computer program product”, “tangibly embodied computer program”, etc. or “controller”, “computer”, “processor”, etc., should be understood to also include computers having various architectures such as single/multi-processor architecture, and sequential (Von Neumann)/parallel architecture, as well as specialized circuits such as field-programmable gate array (FPGA), application-specific integrated circuit (ASIC), signal processing devices, and other devices. References to a computer program, instructions, codes, etc., should be understood to include software for programmable processors or firmware, such as programmable content of a hardware device, whether it is instructions for a processor, or configuration settings for a fixed-function device, a gate array, or a programmable logic device.

Further, in the present disclosure, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the alternations within the equivalent scope of the present invention belong to the scope of the present invention.

What is claimed is:

1. A computerized method comprising:
specifying data to be forgotten and data to be retained for a pre-trained large language model in a training dataset stored in memory;
specifying a parameter having a high importance based on a preset reference criterion for the data to be forgotten among a plurality of parameters of the large language model by comparing the data to be forgotten and the data to be retained, wherein the high importance exceeds the preset reference criterion;
initializing a weight of low-rank adaptation based on the parameter having the high importance for the data to be forgotten; and
performing unlearning on the large language model to which the weight of the low-rank adaptation is applied.

2. The computerized method of claim 1, further comprising:
calculate a parameter importance for each of the data to be forgotten and the data to be retained by using a Fisher information matrix.

3. The computerized method of claim 2, wherein the Fisher information matrix includes a value indicating importance of at least one parameter of the large language model for a text sample included in the data to be forgotten or the data to be retained.

4. The computerized method of claim 3, wherein a parameter having a higher absolute value of a gradient for the data to be forgotten has a higher importance in the data to be forgotten, and a parameter having a higher absolute value of a gradient for the data to be retained has a higher importance in the data to be retained.

5. The computerized method of claim 2, wherein the calculating of the parameter importance comprises:
calculating a Fisher information matrix for the data to be forgotten and a Fisher information matrix for the data to be retained by using the data to be forgotten and the data to be retained, and
calculating the parameter importance by using the Fisher information matrix for the data to be forgotten and the Fisher information matrix for the data to be retained.

6. The computerized method of claim 5, wherein the parameter importance is calculated using a relative Fisher information matrix between the Fisher information matrix for the data to be forgotten and the Fisher information matrix for the data to be retained.

7. The computerized method of claim 6, wherein the relative Fisher information matrix is calculated using the Fisher information matrix for the data to be forgotten and the Fisher information matrix for the data to be retained.

8. The computerized method of claim 7, wherein the specifying of the parameter having the high importance for the data to be forgotten comprises specifying the parameter having a high parameter importance for the data to be forgotten, based on the relative Fisher information matrix.

9. The computerized method of claim 8, wherein the parameter is specified as a specific parameter having the high importance for the data to be forgotten and a relatively low importance for the data to be retained.

10. The computerized method of claim 1, wherein the initializing of the weight of the low-rank adaptation comprises calculating a relative importance of a parameter for the data to be forgotten and a parameter of the data to be retained.

11. The computerized method of claim 10, wherein the initializing of the weight of the low-rank adaptation comprises initializing and centering the weight of the low-rank adaptation on the one parameter having the high importance for the data to be forgotten.

12. The computerized method of claim 10, wherein importance of the data to be forgotten is reflected in the initializing of the weight of the low-rank adaptation.

13. The computerized method of claim 1, wherein the performing of the unlearning on the large language model comprises performing the unlearning of the data to be forgotten using a preset loss function.

14. The computerized method of claim 13, wherein the performing of the unlearning on the large language module comprises, performing the unlearning on the large language model by using the preset loss function so that a prediction probability for the data to be retained is increased and a prediction probability for the data to be forgotten is decreased.

15. The computerized method of claim 13, wherein the performing of the unlearning on the large language model comprises decreasing a prediction probability of the large language model for a true token included in the data to be forgotten and increasing a prediction probability of the large language model for an alternative token having a highest probability among all tokens excluding the true token to decrease the prediction probability for the data to be forgotten.

16. The computerized method of claim 15, wherein the alternative token has a highest possibility of replacing the true token among the all tokens excluding the true token.

17. The computerized method of claim 13, wherein, when the unlearning on the large language model is performed, parameters of the large language model are constant and the weight of the low-rank adaptation is changed.

18. A system comprising:
memory configured to store executable instructions; and
one or more processors configured to execute one or more of the instructions to perform operations comprising:
specifying data to be forgotten and data to be retained for a pre-trained large language model in a training dataset stored in the memory;
specifying a parameter having a high importance based on a preset reference criterion for the data to be forgotten among a plurality of parameters of the large language model by comparing the data to be forgotten and the data to be retained, wherein the high importance exceeds the preset reference criterion;
initializing a weight of low-rank adaptation based on the parameter having the high importance for the data to be forgotten; and
performing unlearning on the large language model to which the weight of the low-rank adaptation is applied.

19. A non-transitory computer-readable storage medium having instructions that, when executed by one or more processors, cause the one or more processors to:
specify data to be forgotten and data to be retained for a pre-trained large language model in a training dataset;
specify a parameter having a high importance based on a preset reference criterion for the data to be forgotten among a plurality of parameters of the large language model by comparing the data to be forgotten and the data to be retained, wherein the high importance exceeds the preset reference criterion;
initialize a weight of low-rank adaptation based on the parameter having the high importance for the data to be forgotten; and
perform unlearning on the large language model to which the weight of the low-rank adaptation is applied.
